(19) United States
(12) Patent Application Publication
(10) Pub. No.: US 2025/0039714 A1
(43) Pub. Date: Jan. 30, 2025

(54) SYSTEMS AND METHODS FOR REPORTING UPPER LAYER INDICATIONS AND QUALITY OF EXPERIENCE IN MULTI CONNECTIVITY

(71) Applicant: Telefonaktiebolaget LM Ericsson (PUBL), Stockholm (SE)

(72) Inventors: Luca LUNARDI, GENOVA (IT); Johan Rune, LIDINGÖ (SE); Cecilia Eklöf, TÄBY (SE); Filip BARAC, Huddinge (SE)

(21) Appl. No.: 18/713,044

(22) PCT Filed: Nov. 30, 2022
(86) PCT No.: PCT/SE2022/051126

§ 371 Date: May 23, 2024

Related U.S. Application Data
(60) Provisional application No. 63/284,675, filed on Dec. 1, 2021.

(51) Int. Cl. H04W 24/10; H04L 41/5067

(52) U.S. Cl. CPC H04W 24/10; H04L 41/5067

(57) ABSTRACT

A method (1000) by a user equipment, UE (412), having multi-connectivity to a plurality of network nodes (410) includes receiving (1002), from at least a first network node (410A) of the plurality of network nodes, a Quality of Experience (QoE) measurement configuration comprising an indication to send an application layer indication and/or QoE report. The UE determines (1004) that the application layer indication and/or QoE report cannot be sent to the network node from which the QoE measurement configuration was received. The UE transmits (1006), to another network node (410B) of the plurality of network nodes, the application layer indication and/or QoE report.

### TECHNICAL FIELD

The present disclosure relates, in general, to wireless communications and, more particularly, systems and methods for reporting upper layer indications and Quality of Experience (QoS) in multi-connectivity.

### BACKGROUND

QoE measurements have been specified for Long Term Evolution (LTE) and Universal Mobile Telecommunication System (UMTS), and it is being specified for Next Generation-Radio Access Network (NG-RAN). The purpose of application layer measurements is to measure the experience of the end user when the end user is using certain applications. For example, LTE supports QoE measurements for streaming services and for Mobility Telephony Service for Internet Protocol Multimedia Subsystem (MTSI) services.

The solutions in LTE and UMTS are similar. Generally, QoE Measurement Collection enables configuration of application layer measurements in the user equipment (UE) and the transmission of QoE measurement result files by the UE via Radio Resource Control (RRC) signalling. The application layer measurement configuration received from Operations & Maintenance (O&M) or Core Network (CN) is encapsulated in a transparent container, which is forwarded to the UE in a downlink RRC message. The application layer measurements received from the UE's higher layer are encapsulated in a transparent container and sent to the network in an uplink RRC message. The resulting container is forwarded to a Trace Collector Entity (TCE).

In 3^{rd} Generation Partnership Project (3GPP) Release 17, a study item for “Study on NR QoE management and optimizations for diverse services” for NR has been carried out. The purpose of the study item was to identify solutions for QoE measurements in New Radio (NR). QoE management in NR will not just collect the experience parameters of streaming services but also consider the typical performance requirements of diverse services such as, for example, Augmented Reality (AR) and Virtual Reality (VR).

The measurements may be initiated towards RAN in a management-based manner (i.e., from an Operations Administration and Maintenance (OAM) node) in a generic way for a group of UEs, which may be selected by the RAN. Alternatively, the measurements may be initiated in a signaling-based manner (i.e., initiated from CN on request from the OAM system to RAN) for a single specific UE. The configuration of the measurement includes the measurement details, which is encapsulated in a container that is transparent to RAN.

When initiated via the CN, the measurement is started towards a specific UE. For the LTE case, the “TRACE START” S1AP message is used, which carries, among others, the details about the measurement configuration the application should collect (in the “Container for application layer measurement configuration” Information Element (IE), transparent to the RAN) and the details to reach the trace collection entity to which the measurements should be sent.

Notifications of started and stopped application sessions with associated QoE measurement configurations are introduced, where these notifications are conveyed from the application layer in the UE and to the UE Access Stratum (i.e., the radio layers in the UE) and then forwarded to the network. This allows the network, or at least the RAN, to be aware of when QoE measurements for an application session are ongoing. It is an implementation decision when the RAN stops the measurements. Typically, it is done when the UE has moved outside the configured area for measurement. This may also be referred to as the area scope. However, this strategy may not be effective in providing QoE data that represent complete application sessions.

The basic signaling involved in QoE measurement configuration from the O&M system to the UE is depicted in FIG. 4.2.1-1 in 3GPP TS 28.405 v16.1.0.

Previous techniques for QoE measurement and reporting by a wireless device, such as a UE, include methods for sending indications such as, for example. Session Start Indications or recording session indications, that are received from the upper layers to the RAN node. For example, one such method for handling one or more indications performed by a wireless device operating in a wireless communications network includes determining whether or not to send a first indication of a first type to a network node operating in the wireless communications network. The determining step is based on a first determination of whether or not a previous indication has been received from the network node. The previous indication indicates whether or not uplink transmission, by the wireless device, of another indication of another type is allowed, e.g., whether uplink transmission by the wireless device is to pause or to be resumed. The wireless device processes the first indication based on a first result of the determining of whether or not to send the first indication. The first indication of the first type is one of: a Session Start indication, a Session Stop indication, and a different indication received from an upper layer of the wireless device. The other indication of another type is one of: a report of one or more measurements, e.g., of a quality of experience, QoE, such as QoE measurements for some or all of the applications, or for some or all service types, conventional QoE reporting, such as QoE reporting that is transparent to RAN, reporting of RAN visible QoE, a QoE reporting decodable by the RAN.

Ongoing 3GPP discussion

At RAN3 #113-e meeting, the contribution R3-214043 has been submitted as part of Work Item “NR QoE Management and Optimizations for Diverse Services”. In that contribution, some proposals were made to extend XnAP procedures “S-NG-RAN node Addition Preparation” and “M-NG-RAN node-initiated S-NG-RAN node Modification Preparation” as defined in 3GPP TS 38.423 v16.6.0 The proposed extensions consist of addition of a QoE Assistance Information IE for S-Node as indicated in Table 1 below:

TABLE 1

| | | | IE type and | Semantics |
|---|---|---|---|---|
| IE/Group Name | Presence | Range | reference | description |
| QoE Assistance | | 1 . . . <maxnoof | | |
| information list | | QMC> | | |
| >QoE Reference ID | M | | OCTET STRING | This IE as defined in |
| | | | (SIZE(6)) | TS28.405, |
| | | | | identifies the QoE |
| | | | | measurement |
| | | | | collection job |
| >QoE Collection Entity | M | | Transport Layer | |
| IP Address | | | Address | |
| | | | 9.3.2.3 | |
| >QoE Measurement | M | | ENUMERATED | |
| Status Change | | | (start, | |
| | | | stop, suspend, | |
| | | | resume . . . ) | |
| >MDT Trace ID | M | | OCTET STRING | This IE identifies |
| | | | (SIZE(8)) | the radio-related |
| | | | | MDT session with |
| | | | | the QoE |
| | | | | measurements |

| Range bound | Explanation |
|---|---|
| maxnoofQMC | Maximum no. of QMC for a UE. Value is FFS |

There currently exist certain challenge(s), however. For example, as described above, the previous techniques include a mechanism for a UE Access Stratum to handle the indications (e.g., session start indication) received from upper layers of the UE (e.g., from one or more applications) based on the radio network condition. However, current standard and previous methods lack details describing UE and network behavior with respect to upper layer indications when multi connectivity is used. The same limitation applies to the proposed contribution R3-214043 which indicates possible means on how to support QoE in MR-DC scenario (in particular in relation to XnAP procedures “S-NG-RAN node Addition Preparation” and “M-NG-RAN node-initiated S-NG-RAN node Modification Preparation”).

One specific issue is that the mechanism for pausing of QoE reporting such as, for example, due to overload, and the treatment of session start and session stop indications in conjunction with this, does not take into account is the possibility of multi-connectivity (e.g. Evolved-Universal Terrestrial Radio Access-NR Dual Connectivity (EN-DC), New Radio-Dual Connectivity (NR-DC), NG-RAN Evolved-Universal Terrestrial Radio Access-NR Dual Connectivity (NGEN-DC), NR-E-UTRA Dual Connectivity (NE-DC)) where multiple UE-RAN paths and multiple RAN nodes are involved.

### SUMMARY

Certain aspects of the disclosure and their embodiments may provide solutions to these or other challenges. For example, methods and systems are provided to exploit opportunities offered when UE is operating in multi-connectivity or when multi-connectivity radio related procedures are executed and to handle upper layer indications and associated information. Specifically, systems and methods are disclosed that enable UE Access Stratum (AS) operating in multi-connectivity to send indications (e.g. Session Start Indication or Session Stop Indication) and/or associated information (e.g. time stamps, session duration) and/or QoE reports received from an upper/application layer of the UE to the RAN, even when one of the paths comprised in the multi-connectivity cannot be used (e.g. because one of the RAN nodes comprised in multi-connectivity has indicated to pause indications and/or QoE reporting).

According to certain embodiments, a method by a UE having multi-connectivity to a plurality of network nodes includes receiving, from a network node oof the plurality of network nodes, a Quality of Experience, QoE, measurement configuration comprising an indication to send an application layer indication and/or QoE report. The UE determines that the application layer indication and/or QoE report cannot be sent to the network node from which the QoE measurement configuration was received. The UE transmits, to another network node of the plurality of network nodes, the application layer indication and/or QoE report.

According to certain embodiments, a method by a network node serving a UE that has multi-connectivity to the network node and at least another network node includes transmitting, to the UE, a QoE measurement configuration comprising an indication to send an application layer indication and/or QoE report. The network node determines that the application layer indication and/or QoE report cannot be sent to the network node.

According to certain embodiments, a method by a network node serving a UE that has multi-connectivity to the network node and at least another network node includes transmitting, to the other network node, a request to receive an application layer indication and/or QoE report of the UE. The network node receives the application layer indication and/or QoE report of the UE.

According to certain embodiments, a method by a network node serving a UE that has multi-connectivity to the network node and at least another network node includes receiving, from the other network node, a request to receive an application layer indication and/or QoE report of the UE. The network node receives, from the UE, the application layer indication and/or QoE report of the UE. The network node transmits, to the other network node, the application layer indication and/or QoE report of the UE.

According to certain embodiments, a UE having multi-connectivity to a plurality of network nodes is configured to receive, from a network node oof the plurality of network nodes, a Quality of Experience, QoE, measurement configuration comprising an indication to send an application layer indication and/or QoE report. The UE is configured to determine that the application layer indication and/or QoE report cannot be sent to the network node from which the QoE measurement configuration was received. The UE is configured to transmit, to another network node of the plurality of network nodes, the application layer indication and/or QoE report.

According to certain embodiments, a network node serving a UE that has multi-connectivity to the network node and at least another network node is configured to transmit, to the UE, a QoE measurement configuration comprising an indication to send an application layer indication and/or QoE report. The network node is configured to determine that the application layer indication and/or QoE report cannot be sent to the network node.

According to certain embodiments, a network node serving a UE that has multi-connectivity to the network node and at least another network node is configured to includes transmit, to the other network node, a request to receive an application layer indication and/or QoE report of the UE. The network node is configured to receive the application layer indication and/or QoE report of the UE.

According to certain embodiments, a network node serving a UE that has multi-connectivity to the network node and at least another network node is configured to receive, from the other network node, a request to receive an application layer indication and/or QoE report of the UE. The network node is configured to receive, from the UE, the application layer indication and/or QoE report of the UE. The network node is configured to transmit, to the other network node, the application layer indication and/or QoE report of the UE.

Certain embodiments may provide one or more of the following technical advantage(s). For example, certain embodiments may provide a technical advantage of overcoming a limitation in case of multi-connectivity, where a path that has been set up for the transfer of upper layer indications from UE AS to RAN cannot be used. The limitation can happen, for example, when the RAN node that is due to receive the QoE report(s) has indicated to the UE AS that QoE reports should be paused.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIGS. 1A, and 1B illustrate a first high-level example flowchart of an example method where UE AS is initially in single connectivity and later reconfigured to multi-connectivity, according to certain embodiments:

FIGS. 2A, 2B, 2C, AND 2D illustrate a second high-level example flowchart of an example method where UE AS is initially configured according to a first radio configuration in multi connectivity and later reconfigured to a second radio configuration, also in multi-connectivity, according to certain embodiments:

FIGS. 3A, 3B, and 3C illustrate a third high-level example flowchart of an example method where the UE AS is initially configured according to a first radio configuration in multi connectivity and later reconfigured to a second radio configuration, also in multi-connectivity, according to certain embodiments:

FIG. 4 illustrates an example communication system, according to certain embodiments:

FIG. 5 illustrates an example UE, according to certain embodiments:

FIG. 6 illustrates an example network node, according to certain embodiments:

FIG. 7 illustrates a block diagram of a host, according to certain embodiments:

FIG. 8 illustrates a virtualization environment in which functions implemented by some embodiments may be virtualized, according to certain embodiments:

FIG. 9 illustrates a host communicating via a network node with a UE over a partially wireless connection, according to certain embodiments:

FIG. 10 illustrates a method by a UE having multi-connectivity to a plurality of network nodes, according to certain embodiments:

FIG. 11 illustrates a method by a network node serving a UE that has multi-connectivity to the network node and at least another network node, according to certain embodiments:

FIG. 12 illustrates another method by a network node serving a UE that has multi-connectivity to the network node and at least another network node, according to certain embodiments; and

FIG. 13 illustrates another method by a network node serving a UE that has multi-connectivity to the network node and at least another network node, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

Herein, the terms “UE”, “terminal equipment”, “wireless terminal” and “terminal”, “wireless device” are used interchangeably.

The terms “QoE measurement report”, “QoE report”, “measurement report” and “report” are used interchangeably.

The terms UE RRC configuration, UE RRC context, RRC configuration, RRC context, or just configuration and context are used interchangeably.

The terms “QoE measurement configuration”, “QoE measurement and reporting configuration”, “QoE measurement”, “QoE configuration” and “application layer measurement configuration” are used interchangeably. In some cases, the term “QoE measurement”, which typically refers to a measurement or data collection performed for the purpose of determining a QoE metric, may also refer to a QoE measurement configuration.

The terms “QoE measurement configuration container”, “QoE configuration container” and “QMC configuration file” are considered equivalent herein.

The terms “Session Start indication”, “Recording Session Indication”, and in some cases “indication” are used interchangeably.

Herein, the Session Start Indication is used as an example: however, the systems, methods, and embodiments described herein can be applied to any indication that a UE access stratum may receive from the upper layer/applications.

The terms “service” and “application” are used interchangeably.

The terms “Measurement Collector Entity (MCE)” and “Trace Collector Entity (TCE)” are used interchangeably and may both be seen as example realizations of a QoE CE.

The term “pause” (such as in “pause indication”) is often used herein as an equivalent to “pause QoE measurement reporting”. Similarly, the term “resume” (such as in “resume indication”) is often used herein as an equivalent to “resume QoE measurement reporting”.

A network node can be a RAN node, a gNodeB (gNB), eNodeB (eNB). Enhanced gNB (en-gNB). Next Generation-eNG (ng-eNB), gNB-Centralized Unit (gNB-CU), gNB-CU-Control Plane (gNB-CU-CP), gNB-CU-User Plane (gNB-CU-UP), gNB-Distributed Unit (gNB-DU), eNB-Centralized Unit (eNB-CU), eNB-CU-Control Plane (eNB-CU-CP), eNB-CU-User Plane (eNB-CU-UP), eNB-Distributed Unit (eNB-DU). Integrated Access and Backhaul (IAB)-nodes. IAB-donors, IAB-donor-Centralized Unit (IAB-donor-CU), IAB-donor-CU-Control Plane (IAB-donor-CU-CP), IAB-donor-CU-User Plane (IAB-donor-CU-UP), IAB-donor-Distributed Unit (IAB-donor-DU), IAB-Mobile Termination (IAB-MT), O-RAN-Centralized Unit (O-CU), O-RAN-CU-Control Plane (O-CU-CP), O-RAN-CU-User Plane (O-CU-UP), O-RAN-Distributed Unit (O-DU), O-RAN-Radio Unit (O-RU), O-RAN eNB (O-eNB), a CN node, an OAM node, and/or an Service Management and Orchestration (SMO) node.

The terms “legacy QoE metrics” and “regular QoE metrics” refer to the application layer measurements for different services defined in 3GPP SA4 specifications (e.g., TS 26.247 for 3GP-DASH streaming service and progressive download, or TS 26.118 for VR profiles for streaming applications), which are delivered from the UE to a network entity via RAN, where RAN is unable to read the QoE reports containing the measured values of these metrics.

The term “RAN visible QoE” and the corresponding abbreviation “RV-QOE”. “RVQoE” or “rvqoe” are used interchangeably.

When used herein, the term “RAN visible QoE” may comprise RAN visible QoE measurement. RAN visible QoE measurement reporting. RAN visible QoE parameters and metrics, processing of information to derive RAN visible QOE parameters/metrics/information/data, and the term “RAN visible QoE” may also be used to refer to the overall framework for RAN visible QoE.

The terms “app identifier”, “application identifier”, “app identity”, “application identity”, “app ID” and “application ID” are used interchangeably herein.

Though certain embodiments are mainly described in terms of 3GPP 5G/NR, the solutions, techniques, and embodiments described herein are equally applicable in other communication systems such as, for example, LTE.

The solutions, techniques, and embodiments are mainly described based on a scenario where (one of the) RAN node(s) serving the UE issues a reporting pause indication to the UE. However, the solutions, techniques, and embodiments also pertain to any reason due to which reporting cannot be executed over the intended leg in multi-connectivity, a non-limiting example of such reason being radio link failure of a leg.

According to certain embodiments, methods are described to enable a UE Access Stratum (AS) using multi-connectivity or involved in multi-connectivity radio related procedures, for managing upper layer indication(s) and/or associated information, and/or QoE report(s) to be sent from the UE Application Layer to the UE AS and from the UE AS to a RAN node, when a RAN node has indicated to the UE AS to pause the sending of upper layer indication (second indication(s)) and/or associated information and/or QoE report(s) to the RAN node.

For example, methods and systems provide a mechanism for a UE AS to handle upper layer indications such as, for example, application layer indications such as session start indications or session stop/end indications that are received from applications when multi-connectivity procedures are ongoing or multi-connectivity is established between UE and RAN. For example, the methods and systems disclosed herein extend the previous techniques and methods in a wireless terminal for sending indications such as Session Start Indications or recording session indications received from the upper layers to the RAN node.

According to certain embodiments, a UE AS determines whether upper layer indications and/or associated information can be sent to one or more RAN nodes comprised in the radio configuration. In a particular embodiment, the associated information may include time stamps, session duration, etc. According to certain embodiments:
The UE AS can be configured according to a first radio configuration comprising one RAN node (“first RAN node of the first radio configuration”) or comprising two RAN nodes (“first RAN node of the first radio configuration” and “second RAN node of the first radio configuration”).
The UE AS can be configured according to a second radio configuration comprising one RAN node (“first RAN node of the second radio configuration”) or two RAN nodes (“first RAN node of the second radio configuration” and “second RAN node of the second radio configuration”).
The UE AS can be reconfigured from the first radio configuration to the second radio configuration, where one or both RAN nodes serving the UE are changed when the UE is reconfigured.

In a particular embodiment, the methods and systems apply also to scenarios wherein the UE AS is configured according to a first radio configuration comprising two RAN nodes and remains in the same radio configuration. A radio configuration with two RAN nodes can be, for example, one of following types: EN-DC, NR-DC, NGEN-DC, and NE-DC.

The methods of the solution may be generalized, or extended, to apply to multi-connectivity scenarios/configurations involving more than two RAN nodes, in certain embodiments. It may be noted that, depending on the multi-connectivity radio related procedure, at least one of the following may apply:
The “second RAN node of the first radio configuration” is not comprised in the first radio configuration.
   In one example, “Secondary Node Addition” procedures for EN-DC and for MR-DC with 5GC as respectively described in 3GPP TS 37.340 v16.7.0, clauses 10.2.1 and 10.2.2 are considered. In this case, the first radio configuration only includes one RAN node, the “first RAN node of the first radio configuration”.
The “second RAN node of the second radio configuration” is not comprised in the second radio configuration.
   In one example, “Secondary Node Release” procedures for EN-DC and for MR-DC with 5GC as respectively described in 3GPP TS 37.340 v16.7.0, clauses 10.4.1 and 10.4.2 are considered. In this case, the second radio configuration only includes one RAN node, the “first RAN node of the second radio configuration”.
The “first RAN node of the first radio configuration” coincides with “first RAN node of the second radio configuration.”
   In one example, “Secondary Node Addition” procedures for EN-DC and for MR-DC with 5GC as respectively described in 3GPP TS 37.340 v16.7.0, clauses 10.2.1 and 10.2.2 are considered. In this case, the “first RAN node of the first radio configuration” and the “first RAN node of the second radio configuration” are the same RAN node, and they represent the same Master Node (MN). The “second RAN node of the second radio configuration” is the Secondary Node (SN) comprised in the second radio configuration.
   In another example, “Secondary Node Change (MN/SN initiated)” procedures for EN-DC and for MR-DC with 5GC as respectively described in in 3GPP TS 37.340 v16.7.0, clauses 10.5.1 and 10.5.2 are considered. In this case, the “first RAN node of the first radio configuration” and the “first RAN node of the second radio configuration” are the same, and they represent the same MN. Also, in this case, the “second RAN node of the first radio configuration” is the source SN comprised in the first radio configuration and the “second RAN node of the second radio configuration” is the target SN comprised in the second radio configuration. In this example, the “second RAN node of the second radio configuration” is different from the “second RAN node of the first radio configuration”.
The “second RAN node of the first radio configuration” coincides with the “second RAN node of the second radio configuration.”
   In one example, “Inter-Master Node handover without Secondary Node change” procedures for EN-DC and for MR-DC with 5GC as respectively described in 3GPP TS 37.340 v16.7.0, clauses 10.7.1 and 10.7.2 are considered. In this case, the “second RAN node of the first radio configuration”, indicated as the source SN in the signaling flow, is the same as target SN of the signaling flow, wherein the target SN is in for this case the “second RAN node of the second radio configuration”.
The “first RAN node of the first radio configuration” coincides with the “first RAN node of the second radio configuration” and the “second RAN node of the first radio configuration” coincides with the “second RAN node of the second radio configuration.”
   In one example, a “PSCell change” procedure where the same node is used as MN before and after, and the same node is used as SN before and after (see 3GPP TS 37.340 v16.7.0, clauses 10.6) is considered. In this case, the “first RAN node of the first radio configuration” coincides with the “first RAN node of the second radio configuration” and the “second RAN node of the first radio configuration” coincides with the “second RAN node of the second radio configuration.”
All RAN nodes comprised in first radio configuration and in second radio configuration are different.
In one example, “Inter-Master Node handover with Secondary Node change” procedures for EN-DC and for MR-DC with 5GC as respectively described in 3GPP TS 37.340 v16.7.0, clauses 10.7.1 and 10.7.2 are considered. The source Master Node is different than the target Master Node, and the source Secondary Node is different than the target Secondary Node. In this case, the “first RAN node of the first radio configuration” is the source MN, the “second RAN node of the first radio configuration” is the source SN, the “first RAN node of the second radio configuration” is the target MN, the “second RAN node of the second radio configuration” is the target SN, and all RAN nodes are different from each other.
At least one RAN node is comprised in the “first radio configuration” and in the “second radio configuration,” and the role of the at least one RAN node is changed between the “first radio configuration” and the “second radio configuration.”
   For example, the “Inter-Master Node handover with Secondary Node change” procedures for EN-DC and for MR-DC with 5GC as respectively described in 3GPP TS 37.340 v16.7.0, clauses 10.7.1 and 10.7.2 are considered. The role of at least one of the RAN nodes is changed between the first radio configuration and the second radio configuration. Some non-limiting examples where a role switch can occur are listed here below:
      In the first radio configuration, source MN is a first NG-RAN node (e.g. gNB1), source SN is a second NG-RAN node (e.g. gNB2). In the second radio configuration, target MN is a third NG-RAN node (e.g. gNB3), target SN is the first NG-RAN node (e.g. gNB1).
   In the first radio configuration, source MN is a first NG-RAN node (e.g. gNB1), source SN is a second NG-RAN node (e.g. gNB2). In the second radio configuration, target MN is the second NG-RAN node (e.g. gNB2), target SN is a third NG-RAN node (e.g. gNB3).

According to certain embodiments, a method may include one or more of the following steps:
UE AS receives from a RAN node comprised in a radio configuration one or a list of QoE configurations for one or more service types or service subtypes, wherein QoE configuration(s) can be related to conventional QoE (i.e. QoE measurements not interpretable by RAN) or can be related to RAN visible QoE (i.e. QoE measurements and values interpretable by RAN), or both conventional QoE and RAN visible QoE. Note that a list of QoE configurations may comprise multiple QoE configurations associated with the same service type, the same service subtype, multiple service subtypes, and/or multiple service types.
UE AS sends, to UE Application Layer (e.g. via AT commands), the received QoE configuration(s).
UE AS receives, from UE Application Layer (e.g. via AT commands), QoE reports(s).
UE AS receives, from UE Application Layer, upper layer indications (e.g. Session Start, Session Stop/End indications).

For better clarity and to provide a more compact description, the following notations are used below:
A first indication is an indication sent from one of the RAN nodes comprised in the first radio configuration.
A second indication is an upper layer indication (i.e, an application layer indication) or an information associated to upper layer information, such as one of:
   a Session Start indication
   a Session Stop indication
   a Session End indication
   a Session Pause/Delay/Resume/Restart indication
   a different indication received from an upper layer of the UE
   a timestamp for a session related indication (e.g. Session Start, Session Stop, Session End)
   a session duration
   a status of the session (e.g. failed, successful)
   number of sessions
   a service type
   a service subtype
   an application identifier
   an Single Network Slice Selection Assistance Information (S-NSSAI)
A third indication is an indication sent from one of the RAN nodes comprised in the second radio configuration, and it can be sent as part of a signaling procedure leading to the reconfiguration of the UE AS form the first radio configuration to the second radio configuration, or after the UE AS has been reconfigured according to the second radio configuration.
A first indication and a third indication refer to or are associated with at least a service type or at least a service subtype or at least one application comprised in or referenced by QoE configuration(s) received by UE AS, and they can indicate one of the following actions pertaining to the sending, from UE AS to a RAN node, of upper layer indications and/or QoE reports:
   pause
   resume
   start/restart
   stop/temporary stop
   reset
A QoE report can be a conventional QoE report (not interpretable by RAN) or a RAN visible QoE report/values/scores.

According to certain embodiments, a UE AS is initially configured with a first radio configuration, which may comprise one RAN node (the first RAN node of the first radio configuration) or two RAN nodes (the first RAN node of the first radio configuration and the second RAN node of the first radio configuration).

The UE AS may be later reconfigured from a first radio configuration to a second radio configuration, and the second radio configuration can comprise one RAN node (the first RAN node of the second radio configuration) or two RAN nodes (the first RAN node of the second radio configuration and the second RAN node of the second radio configuration). Depending on the reconfiguration procedure, one of the following is possible:
The “second RAN node of the first radio configuration” is not comprised in the first radio configuration.
The “second RAN node of the second radio configuration” is not comprised in the second radio configuration.
The “first RAN node of the first radio configuration” coincides with the “first RAN node of the second radio configuration.”
The “second RAN node of the first radio configuration” coincides with the “second RAN node of the second radio configuration.”
The “first RAN node of the first radio configuration” coincides with the “first RAN node of the second radio configuration,” and the “second RAN node of the first radio configuration” coincides with the “second RAN node of the second radio configuration.”
All RAN nodes comprised in first radio configuration and in second radio configuration are different.
At least one RAN node is comprised in the “first radio configuration” and in the “second radio configuration”, and the role of the at least one RAN node is changed between the “first radio configuration” and the “second radio configuration.”

In a particular embodiment, the UE AS has received a first indication to pause sending of second indication(s) and/or to pause sending QoE report(s) without having received a corresponding first indication indicating to resume said paused sending of second indication(s) and/or sending of QoE report(s), and the UE AS determines whether the sending of second indication(s) and/or QoE report(s) is possible to one or more RAN nodes when one of the following conditions occur:
While configured according to a first radio configuration comprising two RAN nodes, and upon reception by UE AS of a first indication, indicating to pause or to resume the sending of second indication(s) and/or QoE report(s) for at least a service type or a service subtype or an application,
   the first indication can be received from a first RAN node of the first radio configuration, or from a second RAN node of the first radio configuration.
Upon reception of a second indication from the application layer, while configured according to the first radio configuration comprising two RAN nodes, wherein the UE AS has received a first indication indicating to pause the sending of second indication(s), without having received a corresponding first indication indicating to resume said paused sending of second indication(s).
While reconfiguring or upon completion of reconfiguration of UE AS from a first radio configuration comprising one RAN node to a second radio configuration comprising two RAN nodes, the UE AS receives a third indication (from one of the RAN nodes comprised in the second radio configuration), indicating that sending second indications and/or QoE reports to one of the RAN nodes comprised in the second radio configuration is possible.
While reconfiguring or upon completion of reconfiguration of UE AS from a first radio configuration comprising two RAN nodes to a second radio configuration comprising two RAN nodes, the UE AS receives a third indication (from one of the RAN nodes comprised in the second radio configuration), indicating that sending second indications and/or QoE reports to one of the RAN nodes comprised in the second radio configuration is possible.
While reconfiguring or upon completion of reconfiguration of UE AS from a first radio configuration comprising two RAN nodes to a second radio configuration comprising one RAN node, the UE AS receives a third indication (from one of the RAN nodes comprised in the second radio configuration), indicating that sending second indications and/or QoE reports to one of the RAN nodes comprised in the second radio configuration is possible.
While configured according to the second radio configuration comprising two RAN nodes, and upon reception by UE AS of a third indication, indicating to pause or to resume the sending of second indication(s) and/or QoE report(s) for at least a service type or a service subtype or an application,
   the third indication can be received from a first RAN node of the second radio configuration, or from a second RAN node of the second radio configuration.
While configured according to the second radio configuration comprising two RAN nodes, and upon reception of an indication, indicating that one RAN node is deactivated. This e.g. comprises the cases where the Secondary Node (SN) is deactivated (in case of dual connectivity) or the case where SCell(s) are deactivated (in case of carrier aggregation).
Radio link failure on a link (i.e., the multi-connectivity leg), towards one of the two RAN nodes serving the UE where the leg subject to failure is the leg configured for sending the second indications and/or QoE reports.

According to various particular embodiments, the UE AS determines that sending of second indication(s) and/or sending of QoE report(s) is possible:
to the first RAN node of the first radio configuration, provided that UE AS is configured according to a first radio configuration comprising two RAN nodes, and:
   Either the UE AS received a first indication from the second RAN node of the first radio configuration, the first indication indicating that sending of QoE reports or/and sending of application layer related indications (such as Session Start and/or Session Stop/End indications) from the UE AS to the second RAN node of the first radio configuration is paused, OR the UE AS determined that the link towards the second RAN node of the first radio configuration is subject to radio link failure,
   AND that at least one of the following conditions is also fulfilled:
      UE AS has NOT received a first indication from the first RAN node of the first radio configuration, the first indication indicating that sending of QoE reports or/and sending of application layer related indications (such as Session Start and/or Session Stop/End indications) from the UE AS to the first RAN node of the first radio configuration is paused,
      OR
      UE AS received a first indication from the first RAN node of the first radio configuration, the first indication indicating that sending of QoE reports or/and sending of application layer related indications (such as Session Start and/or Session Stop/End indications) from the UE AS to the first RAN node of the first radio configuration is paused, and another first indication from the first RAN node of the first radio configuration, the another first indication indicating that sending of QoE reports or/and sending of application layer related indications (such as Session Start and/or Session Stop/End indications) from the UE AS to the first RAN node of the first radio configuration is resumed (and the another first indication is the last first indication the UE AS has received from the first RAN node of the first radio configuration).
      OR
      UE AS received an indication that the second RAN node of the first configuration is deactivated.
      OR
      UE AS received an indication that certain SCell(s) is (are) deactivated.
To the second RAN node of the first radio configuration, provided that UE AS is configured according to a first radio configuration comprising two RAN nodes, and:
   Either the UE AS received a first indication from the first RAN node of the first radio configuration, the first indication indicating that sending of QoE reports or/and sending of application layer related indications (such as Session Start and/or Session Stop/End indications) from the UE AS to the first RAN node of the first radio configuration is paused, OR the UE AS determined that the link towards the first RAN node of the first radio configuration is subject to radio link failure
   AND that at least one of the following conditions is also fulfilled:
   UE AS has NOT received a first indication from the second RAN node of the first radio configuration, the first indication indicating that sending of QoE reports or/and sending of application layer related indications (such as Session Start and/or Session Stop/End indications) from the UE AS to the second RAN node of the first radio configuration is paused,
   OR
   UE AS received a first indication from the second RAN node of the first radio configuration, the first indication indicating that sending of QoE reports or/and sending of application layer related indications (such as Session Start and/or Session Stop/End indications) from the UE AS to the second RAN node of the first radio configuration is paused, and another first indication from the second RAN node of the first radio configuration, the another first indication indicating that sending of QoE reports or/and sending of application layer related indications (such as Session Start and/or Session Stop/End indications) from the UE AS to the second RAN node of the first radio configuration is resumed (and the another first indication is the last first indication the UE AS has received from the second RAN node of the first radio configuration).
To the first RAN node of the second radio configuration, provided that UE AS is configured according to a second radio configuration comprising two RAN nodes, and at least one of the following conditions is fulfilled:
   UE AS received a third indication from the second RAN node of the second radio configuration, the third indication indicating that sending of QoE reports or/and sending of application layer related indications (such as Session Start and/or Session Stop/End indications) from the UE AS to the second RAN node of the second radio configuration is paused.
   OR
   UE AS received an indication that the second RAN node of the second configuration is deactivated.
   OR
   UE AS received an indication that certain SCell(s) is (are) deactivated.
   OR
   The UE AS determined that the link towards the first RAN node of the second radio configuration is subject to radio link failure,
   AND that at least one of the following conditions is also fulfilled:
      UE AS has NOT received a third indication from the first RAN node of the second radio configuration, the third indication indicating that sending of QoE reports or/and sending of application layer related indications (such as Session Start and/or Session Stop/End indications) from the UE AS to the first RAN node of the second radio configuration is paused
      OR
      UE AS has received a third indication from the first RAN node of the second radio configuration, the third indication indicating that sending of QoE reports or/and sending of application layer related indications (such as Session Start and/or Session Stop/End indications) from the UE AS to the first RAN node of the second radio configuration is paused, and another first indication from the first RAN node of the second radio configuration, the another first indication indicating that sending of QoE reports or/and sending of application layer related indications (such as Session Start and/or Session Stop/End indications) from the UE AS to the first RAN node of the second radio configuration is resumed (and the another first indication is the last first indication the UE AS has received from the first RAN node of the second radio configuration).
To the second RAN node of the second radio configuration, provided that UE AS is configured according to a second radio configuration comprising two RAN nodes, and at least one of the following conditions is fulfilled:
   UE AS received a third indication from the first RAN node of the second radio configuration, the third indication indicating that sending of QoE reports or/and sending of application layer related indications (such as Session Start and/or Session Stop/End indications) from the UE AS to the first RAN node of the second radio configuration is paused,
   AND that at least one of the following conditions is fulfilled:
      UE AS has NOT received a third indication from the second RAN node of the second radio configuration, the third indication indicating that sending of QoE reports or/and sending of application layer related indications (such as Session Start and/or Session Stop/End indications) from the UE AS to the second RAN node of the second radio configuration is paused
      OR
      UE AS has received a third indication from the second RAN node of the second radio configuration, the third indication indicating that sending of QoE reports or/and sending of application layer related indications (such as Session Start and/or Session Stop/End indications) from the UE AS to the second RAN node of the second radio configuration is paused, and another first indication from the second RAN node of the second radio configuration, the another first indication indicating that sending of QoE reports or/and sending of application layer related indications (such as Session Start and/or Session Stop/End indications) from the UE AS to the second RAN node of the second radio configuration is resumed (and the another first indication is the last first indication the UE AS has received from the second RAN node of the second radio configuration).

The options above include the case that the UE is configured with a signaling radio bearer (SRB) that may be configured as MN only bearer, SN only bearer, split bearer, or duplicated bearer. The UE may send the indication(s) on the SRB configured in the node where the UE is not paused to send information. If, for example, the UE is not paused in the SN, the UE may send an indication on an SRB configured as an SN only bearer or a split bearer, where the indication is sent in the SN. If, for example, the UE is not paused in the MN, the UE may send on indication on an SRB configured as an MN bearer or a split bearer. In that respect, certain embodiments described herein pertain at least to the following cases:
The indications are sent by the UE AS to the alternative node using the same SRB type as the SRB type used for sending the QoE reports (e.g., SRB4).
   In this case, the alternative RAN node needs to set up the SRB4 towards the UE.
The indications are sent by the UE AS to the alternative node using a different SRB type compared to the SRB type used for sending the QoE reports (e.g., SRB1).
   In this case, the SRB type used for sending the indication towards the alternative node may already exist towards the UE and may not need to be set up.

The determining of whether sending second indication(s) and/or QoE report(s) is possible towards a RAN node comprised in the first radio configuration or in the second radio configuration, further considers the following:
whether a RAN node is comprised in the radio configuration for the UE AS,
whether a RAN node or one or more cells of a RAN node is (are) comprised in the Area Scope defined for a QoE configuration,
whether application layer measurements are configured for a service type or a service subtype or an application,
whether application layer measurements are configured for a S-NSSAI or a list of S-NSSAIs,
whether QoE measurements are of type signaling-based or for management-based,
whether QoE configuration is transparent to RAN or visible to RAN,
whether QoE reporting is transparent to RAN or visible to RAN,
whether MDT measurements and/or other radio related measurements are configured or running for the same UE,
whether a signaling connection, or signaling radio bearer, is already configured between UE AS and a RAN node (e.g. SRB4),
whether, in case a signaling connection/radio bearer is not configured between UE AS and a RAN node (e.g. SRB4), the UE AS may request a RAN node to configure such signaling connection/radio bearer,
the amount of stored/logged data waiting to be sent,
whether a timer is running or not running, which is preventing the sending, and/or
whether one or more filtering conditions or rules regulate the sending of one or more second indication(s), or the sending of one or more QoE report(s), based e.g. on service type, on service subtype, on application related attributes (such as identifier, operating system), on S-NSSAI.
   Filtering conditions may be comprised in a configuration prepared by one of the following: a RAN node, a CN node, or an OAM node and signaled to the UE AS.
   A rule can be e.g. to send only a Session End/Stop indication for which corresponding Session Start indication(s) has/have already been sent (e.g. sent before the first indication to pause sending of QoE reports and/or application layer related indications was received) (i.e, for the same session).
   A priority order, e.g. based on timestamps, time of arrival, S-NSSAI

As outcome(s) of the determination, the UE AS can do one or more or a combination of the following:
store at least part of second indication(s) received from upper layers for some time (e.g. while a timer is running or while a timer is not running or until a timer has expired or stop/refrain to store at least part of second indication(s) received from upper layers while a timer is running or while a timer is not running or until a timer has not expired),
store at least part of QoE report(s) (e.g. as received from upper layers) for some time, e.g. governed by a timer, or until a maximum limit of memory is reached,
send a certain second indication (e.g. a Session End/Stop indication) and/or QoE report(s) only when another second indication (e.g. a Session Start indication) has been received for the same service type(s), service subtype(s), application(s),
send a second indication in the form of a Session Stop/End indication, if the UE AS has previously sent the corresponding Session Start indication to the network,
send upper layer indication(s) and/or associated information and/or QoE report(s) in a certain priority order,
send a time stamp for an indication, e.g. a second indication, and/or QoE report(s),
if second indication(s) and/or QoE report(s) has/have been stored and delayed, or is planned to be stored and delayed, associate a timestamp with each of the affected second indication(s) and/or QoE report(s) and use the timestamp(s) to determine a priority order in which to subsequently send the second indication(s) and/or QoE report(s),
if second indication(s) and/or QoE report(s) has/have been stored and delayed, or is planned to be stored and delayed, associate a timestamp with each of the affected second indication(s) and/or QoE report(s) and, when sending the second indication(s) and/or QoE report(s), send the timestamp(s) together with the respective second indication(s) and/or QoE report(s),
if two or more second indication(s) pertaining to a measurement has/have been stored at the UE AS, and their sending to the network has been delayed, or is planned to be stored and delayed, the UE AS may send to the network only the latest received second indication, for example in case the previously received and stored indication becomes irrelevant. For example, if a “session end” second indication arrives at the UE AS, and the previously received “session paused” indication has not yet been sent to the network, the UE AS may choose to send only the “session end” indication to the network. In a related embodiment, the UE AS may choose not to send any of the previously indications in case they invalidate each other.
send second indication(s) indicating individual or cumulative session duration(s),
send second indication(s) indicating number of sessions,
send second indication(s) and/or QoE reports to one or more of the following:
   the first RAN node of the first radio configuration
   the second RAN node of the first radio configuration
   the first RAN node of the second radio configuration
   the second RAN node of the second radio configuration
send all stored second indication(s) and/or QoE report(s), and/or
send, to a certain RAN node (selected according to one or more of the previously described criteria/conditions), only part (e.g. a subset) of second indication(s).

As non-limiting examples, in certain embodiments, UE AS can:
send latest received second indication, second indication(s) for session(s) pertaining to one or a list of service type(s), to one or a list of service subtype(s), to one or a list of application(s), to one or a list of S-NSSAIs,
discard previously received/store second indication(s) send second indication(s) and/or QoE report(s) pertaining to a certain service type/service subtype/application or to a certain list of service types/service subtypes/applications to a certain RAN node (wherein the RAN node is selected according to one or more of the previously described criteria/conditions),
refrain from sending second indication(s) and/or QoE report(s), and/or
refrain from sending second indication(s) and/or QoE report(s) pertaining to a certain service type/service subtype/application or to a certain list of service types/service subtypes/applications to a certain RAN node.

In some embodiments, when a RAN node sends an indication to a UE to pause QoE reporting and/or sending of application layer related indications, such as Session Start and/or Session Stop and/or Session End indications, and/or other application layer related information, the RAN node indicates whether sending of QoE reports and/or application layer related indications is allowed to another RAN node in a multi-connectivity configuration.

If more than two RAN nodes are involved in the multi-connectivity configuration, the RAN node may indicate to which of the other RAN nodes or serving cells, the UE is allowed to send QoE reports and/or application layer related indications and/or other application layer related information. As one option, this indication could be “allowed to the MN but not to SNs” or “allowed in the MCG but not in the SCG” or “allowed to the SNs but not to the MN” or “allowed in the SCG but not in the MCG.” As another option, the indication could be “allowed to all other RAN nodes in the multi-connectivity configuration” or “allowed to all other serving cells” or “allowed to all serving cells controlled by other RAN node(s).” Optionally, the indication of whether the UE is allowed to send application layer indications and/or QoE reports to other RAN nodes or in other cells is open-ended in the sense that it applies also to future RAN node(s) or cell(s) that are not part of the multi-connectivity configuration at the time of sending the indication. As another option, the rule may apply only to the RAN nodes or cells that are included in the multi-connectivity configuration at the time of sending the indication. As a related option, the indication of if and to which RAN nodes or in which cells the UE is allowed to send application layer indications and/or other application layer related information and/or QoE reports is invalidated if the multi-connectivity configuration is changed or, as a variation, if the multi-connectivity configuration is terminated (i.e. changed into a single connectivity configuration), or if any of the legs constituting the multi-connectivity is subject to radio link failure.

As a further option, these indications of if and to which RAN nodes or in which cells the UE is allowed to send application layer indications and/or other application layer related information and/or QoE reports apply only to information that the UE would otherwise have sent to the RAN node that sent the indication to pause QoE reporting and/or sending of application layer related indications and/or other application layer related information.

As yet further options, each of the above-described indications of if and to which RAN nodes or in which cells the UE is allowed to send application layer indications and/or other application layer related information and/or QoE reports may contain, or be associated with, conditions or specification of the type of information, or nature of information, the indication applies to, e.g. in terms of service type, service subtype, application identifier, etc.

A RAN node, such as one of the RAN nodes comprised in the first radio configuration or in the second radio configuration, that is interested to receive upper layer indication(s) (such as the previously described second indication(s), e.g. from the application layer) and/or associated information and/or QoE report(s) from another RAN node comprised in the first radio configuration or in the second radio configuration, can request to receive said upper layer indication(s) and/or associated information and/or QoE report(s) as part of a radio procedure comprised in multi-connectivity operations, such as those described in 3GPP TS 37.340 v16.7.0 or in TS 38.300 v16.7.0:
Secondary Node Addition,
Secondary Node Modification (MN/SN initiated),
Secondary Node Release (MN/SN initiated),
Secondary Node Change (MN/SN initiated),
PSCell Change,
Master Node to eNB/gNB Change,
eNB/gNB to Master Node change,
Handover (i.e. Master Node Change),
Other reconfigurations, e.g. conditional PSCell Change, activation of Secondary Node, and/or
The above-described reconfigurations, applied to multi-connectivity that involves three or more RAN nodes serving the UE.

A first RAN node can be interested in receiving upper layer indications and/or associated information and/or QoE report(s) from a second RAN node to:
Derive statistics and/or performance indicators from QoE reports (e.g. RV-QoE reports) pertaining to session(s) started in the first RAN node (and where the second RAN node was not involved) and later handled in a connection comprising the second RAN node. Such statistics could be used to optimize radio related functionalities (e.g. optimize handover trigger point, selection of preferred candidate cells as PSCells, etc.)
Collect statistics and/or performance indicators related to session(s), e.g. distribution of session duration per service types, that can be used to train AI/ML models used for radio related functionalities (e.g. mobility load balancing, handover, etc.).

Such a request from a first RAN node to a second RAN node may, in a particular embodiment, be preceded by an indication from the second RAN node to the first RAN node that there is upper/application layer information available that may be of interest to the first RAN node. As another option (continuing with the terms first RAN node and second RAN node), the request from the first RAN node is a “subscription request”, proactively request any future upper/application layer indication(s) and/or associated information and/or QoE report(s) the second RAN node may subsequently receive. As further option, such a “subscription request” may indicate criteria that should be fulfilled for the second RAN node to forward the information (e.g. that the information includes certain parameters or type of data) or that the second RAN node determines that the information may be of interest to the first RAN node. As an alternative to requests for such information, the second RAN node may forward upper/application layer indication(s) and/or associated information and/or QoE report(s) to the first RAN node without prior request/solicitation, optionally selectively based on configured or specified criteria. As yet another option, if the first RAN node and the second RAN node are both included in a multi-connectivity configuration for a UE, and the first RAN node has paused sending of upper/application layer indications (e.g. second indications with the above terminology, e.g. Session Start and/or Session Stop/End indications) and/or QoE reports from the UE, e.g. because the first RAN node is overloaded (in some respect with regards to e.g. the processing capacity, processing capacity for certain tasks (e.g. QoE related processing) or the control plane capacity on the radio interface), and the UE instead sends its upper/application layer indication(s) and/or QoE report(s) to the second RAN node, then the first RAN node may delay its request (for upper/application layer indication(s) and/or QoE report(s)) to the second RAN node until the overload condition (or other reason for pausing the sending of upper/application layer indications and/or QoE reports from the UE) has ceased. To support this, the second RAN node may store the information it receives from the UE that potentially may be requested by the first RAN node. As a further option, the first RAN node may request the second RAN node to perform such storing, and this request may be sent, e.g. in conjunction with the pausing of the UE's sending of upper/application layer indications and/or QoE reports.

In case of gNB split into a gNB-CU and a gNB-DU, for RAN-visible QoE, and for the measurements where the gNB-DU is a consumer of the RAN-visible QoE reports, the gNB-DU may request from the gNB-CU the upper layer indications(s) and/or associated information and/or QoE report(s). With respect to the above-listed multi-connectivity operations, a gNB-CU may obtain from another RAN node (e.g., a gNB, gNB-CU, gNB-DU, an eNB, an en-gNB etc.), on behalf of the gNB-DU, the upper layer indications(s) and/or associated information and/or QoE report(s).

According to certain embodiments, a RAN node can request to another RAN node to receive upper layer indications and/or information associated to upper layer indications and/or QoE report(s), according to various criteria. Non-limiting examples can be to request for one or more or a combination of:
All upper layer information and/or associated information and/or QoE report(s),
All upper layer information and/or QoE report(s),
Neither upper layer information nor associated information nor QoE reports,
Upper layer indication(s) and/or associated information and/or concerning a certain service type/service subtype/application or to a certain list of service types/service subtypes/applications,
Timestamps of upper layer indications (e.g. timestamps related to Session Start and/or Session End/Stop) and/or time stamps of associated information and/or time stamps of QoE report(s),
Number of sessions (overall or per service type, or per service subtype, or per application),
Duration of session(s) (overall or per service type, or per service subtype, or per application),
Upper layer information and/or associated information and/or QoE report(s) for a certain Session,
Upper layer information (e.g. application layer information) and/or associated information and/or QoE report(s) for sessions of a UE or a group of UEs,
Upper layer information (e.g. application layer information) and/or associated information and/or QoE report(s) for sessions occurring over a certain time period,
Upper layer information (e.g. application layer information) and/or associated information and/or QoE report(s) concerning sessions whose communication occurred at least in part over a sidelink in accordance with a sidelink configuration (where sidelink refers to a 3GPP concept that comprises direct UE to UE communication, with variable extent of network control), and
Any of the above, applied to only certain specific types of upper layer information (e.g., only session end indication).

In all or some of the above embodiments involving a RAN node pausing a UE's sending of QoE reports and/or application layer indications and/or other application layer related information, this pausing may apply only to sending of such information to the RAN node that sent the pause indication. In all or some of the above embodiments involving a RAN node pausing a UE's sending of QoE reports and/or application layer indications and/or other application layer related information, and the UE sending such information to another RAN node, the RAN nodes may to a large extent be replaced by cells in the embodiment descriptions. For instance, the pausing may apply only to the cell in which the pause indication is sent or to all cells controlled by the RAN node sending the pause indication. Furthermore, the determination of sending of the concerned information to a certain other RAN node may instead involve per cell determination (i.e. determining whether to send the concerned information in a certain other cell).

Furthermore, in all or some of the above embodiments involving a RAN node pausing a UE's sending of QoE reports and/or application layer indications and/or other application layer related information, and the UE sending, or determining whether to send, such information to another RAN node (or other RAN nodes) or in another cell (or in other cells), this sending, or determination of whether to send, may apply only to information that the UE would otherwise have sent to the RAN node that sent the pause indication. In a related embodiment, the information sent to another RAN node(s) may also contain additional information, such as an indication to another RAN node(s) about which other RAN node was the original intended recipient of the information (this is the node that paused the UE's sending of QoE reports and/or application layer indications and/or other application layer related information). This would enable the said another RAN node(s) to identify and to forward the information to the original intended recipient, e.g., in an unsolicited manner, as explained above.

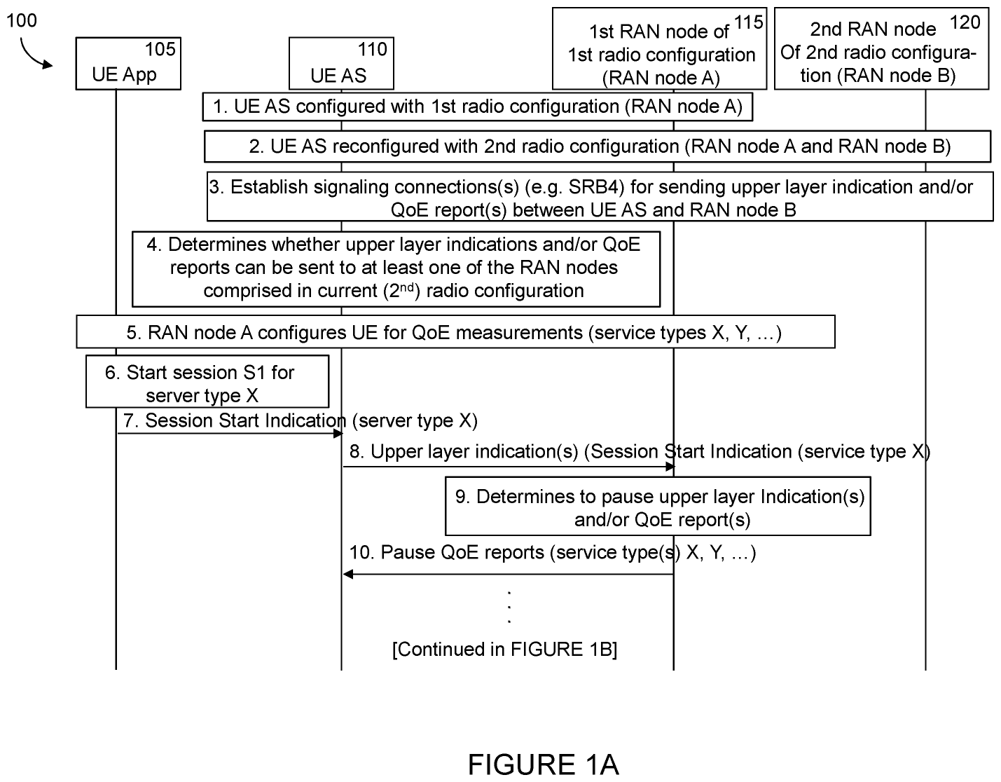

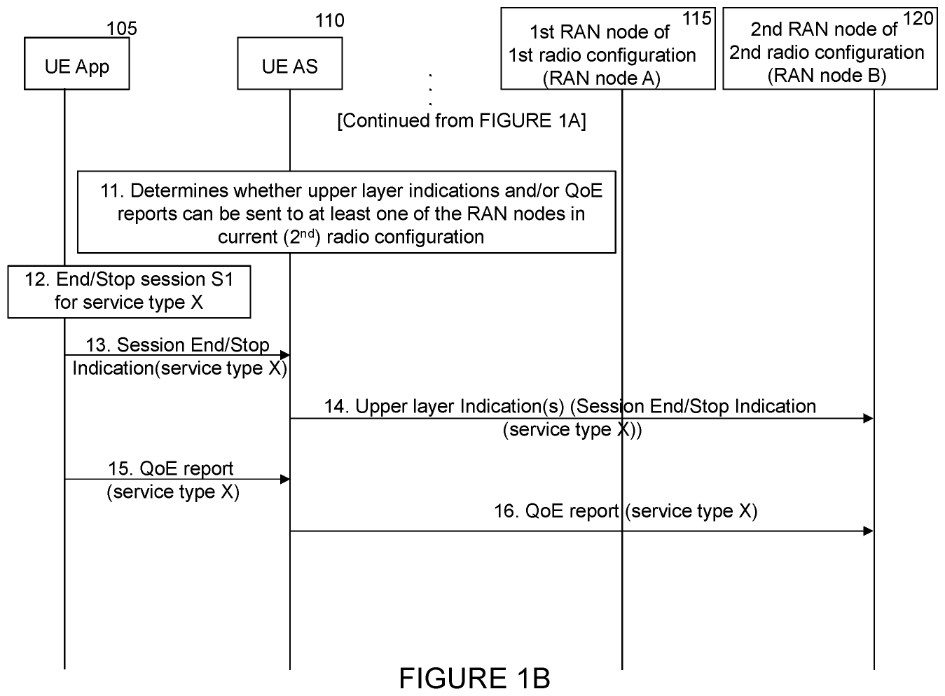

FIGS. 1A, and 1B illustrate a first high-level example flowchart of an example method 100 where UE AS 105 is initially in single connectivity and later reconfigured to multi-connectivity, according to certain embodiments. Specifically. FIGS. 1A, and 1B illustrate example signalling between a UE application or UE application layers (UE App) 105, UE AS 110, first RAN node 115, and second RAN node 120. The UE App 105 sends upper layer indication(s) and/or associated information and/or QoE report(s) to the second RAN node 120 in case a pause indication is received from the first RAN node 115. In the flowchart:
The “first RAN node of the first radio configuration” 115 is RAN node A.
The “first RAN node of the second radio configuration” 115 is RAN node A.
The “second RAN node of the second radio configuration” 120 is RAN node B

As illustrated in FIGS. 1A, and 1B, the method may include one or more or a combination of any of the following steps:
Step 1: UE AS 110 is configured according to a first radio configuration, comprising RAN node A 115.
Step 2: UE AS 110 is reconfigured to a second radio configuration, comprising RAN node A 115 and RAN node B 120. The first RAN node of the first radio configuration is the same as the first RAN node of the second radio configuration. As an example, a multi-connectivity radio procedure involved in this case can be a “Secondary Node Addition”.
Step 3: As part of the reconfiguration procedure, or associated to it, a signaling connection can be established (e.g. SRB4) between UE AS 110 and RAN node B 120.
Step 4: UE AS 110 determines whether it is possible to send upper layer indication(s) and/or associated information and/or QoE report(s) to at least one of the RAN nodes comprised in the second radio configuration. At this stage, sending is possible to both RAN node A 115 and RAN node B 120.
Step 5: One of the RAN nodes in the second radio configuration (in the example the first RAN node of the second radio configuration 115, i.e. RAN node A) configures UE for QoE measurements. Note that Step 4 may be performed before any of the Step 1, Step 2, Step 3.
Step 6: A Session S1 starts in UE App 105.
Step 7: UE App 105 sends to UE AS 110 a Session Start indication for session S1.
Step 8: UE AS 110 sends a Session Start indication for session S1 to the first RAN node of the second radio configuration (RAN node A) 115.
Step 9: The first RAN node of the second radio configuration 115 determines to pause the sending of upper layer indication(s) and/or associated information and/or QoE report(s) from UE AS 110.
Step 10: The first RAN node of the first radio configuration 115 sends a pause indication to UE AS 110.
Step 11: UE AS 110 determines whether it is possible to send upper layer indication(s) and/or associated information and/or QoE report(s) to at least one of the RAN nodes comprised in the second radio configuration. At this stage, sending is possible only to RAN node B 120.
Step 12: Session S1 is stopped/end in UE Application Layer 105.
Step 13: UE App 105 sends to UE AS 110 a Session End/Stop indication for session S1.
Step 14: UE AS 110 sends Session End/Stop indication to RAN node B 120.
Step 15: UE App 105 sends to UE AS 110 a QoE report for session S1.
Step 16: UE AS 110 sends the QoE report to RAN node B 120.

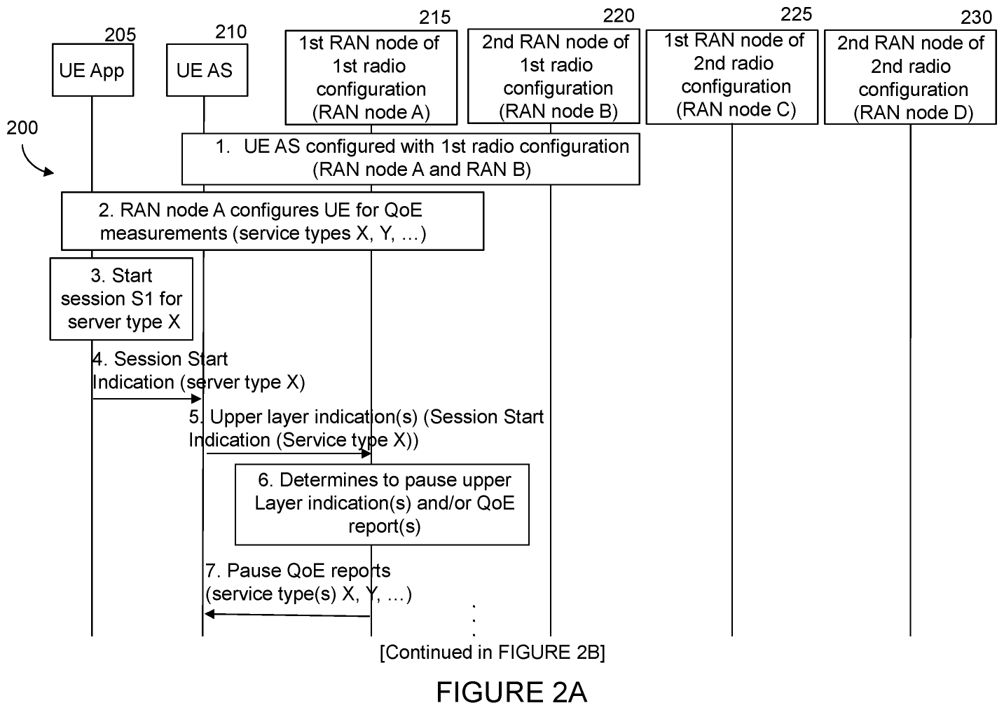

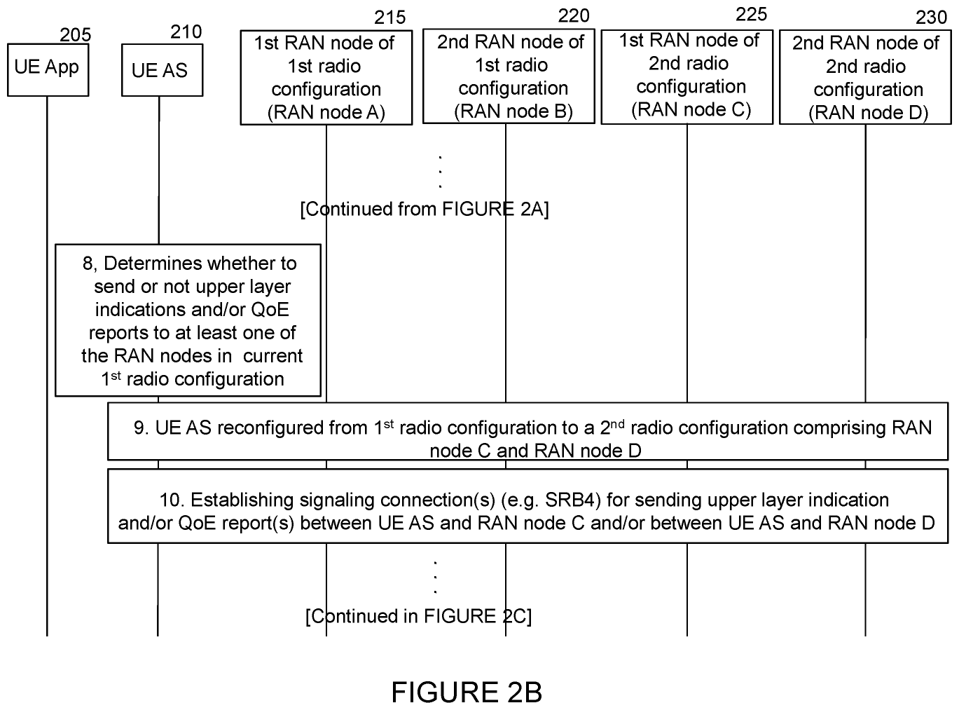

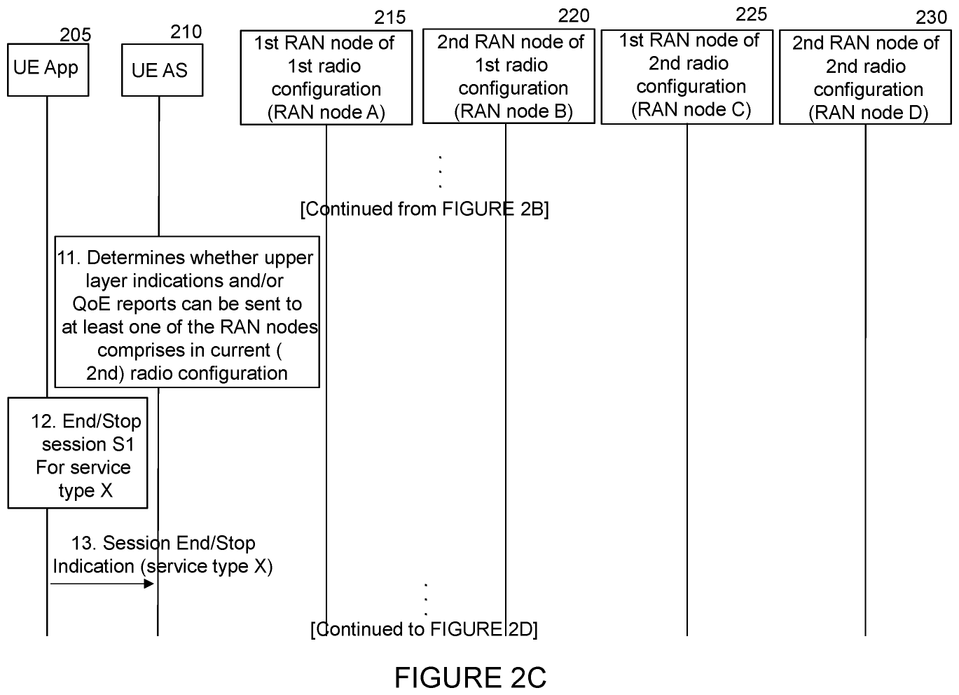

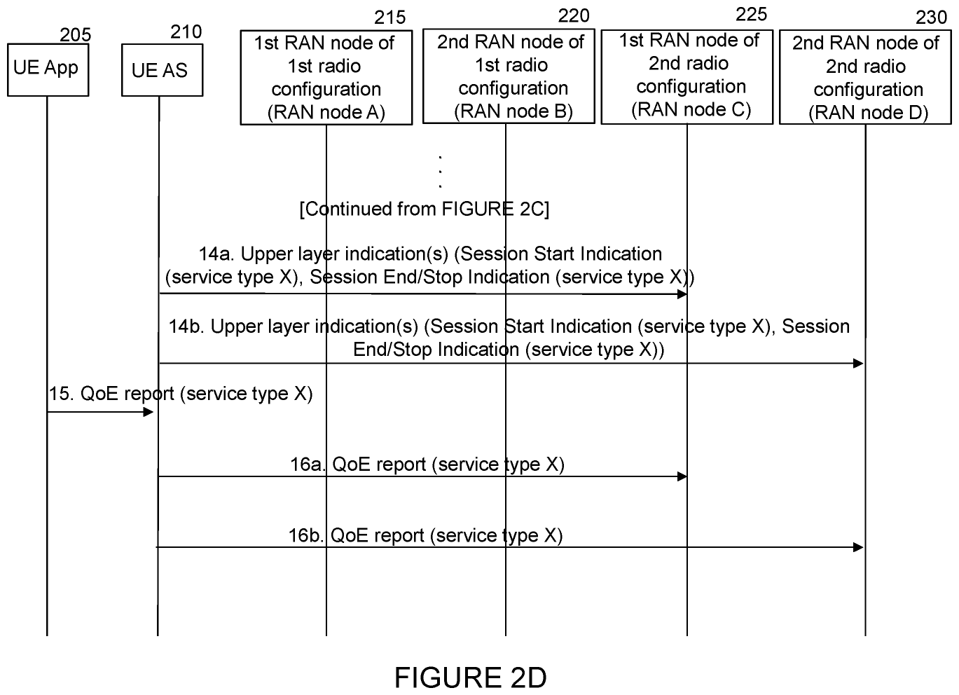

FIGS. 2A, 2B, 2C, and 2D illustrate a second high-level example flowchart of an example method 200 where UE AS is initially configured according to a first radio configuration in multi connectivity and later reconfigured to a second radio configuration, also in multi-connectivity, according to certain embodiments. Specifically, FIGS. 2A, 2B, 2C, and 2D illustrate example signalling 200 between a UE App 205, UE AS 210, first RAN node of first radio configuration 215, second RAN node of first radio configuration 220, first RAN node of second radio configuration 225, and second RAN node of second radio configuration 230. A pause indication is sent from the first RAN node of the first radio configuration 215 to UE AS 210. In the flowchart of FIGS. 2A, 2B, 2C, AND 2D:
The “first RAN node of the first radio configuration” 215 is RAN node A.
The “second RAN node of the first radio configuration 220 is RAN node B.
The “first RAN node of the second radio configuration” 225 is RAN node C.
The “second RAN node of the second radio configuration 230 is RAN node D.

As illustrated in FIGS. 2A, 2B, 2C, AND 2D, the method may include one or more or a combination of any of the following steps:
Step 1: UE AS 210 is configured according to a first radio configuration, comprising RAN node A 215 and RAN node B 220.
Step 2: One of the RAN nodes in the first radio configuration (in the example the first RAN node of the first radio configuration, i.e. RAN node A 215) configures UE for QoE measurements. Note that Step 2 may be performed before Step 1, in certain embodiments.
Step 3: A Session S1 starts in UE App 205.
Step 4: UE App 205 sends to UE AS 210 a Session Start indication for session S1.
Step 5: UE AS 210 sends a Session Start indication for session S1 to the first RAN node of the first radio configuration (RAN node A) 215.
Step 6: The first RAN node of the first radio configuration 215 determines to pause the sending of upper layer indication(s) and/or associated information and/or QoE report(s) from UE AS 210.
Step 7: The first RAN node of the first radio configuration 215 sends a pause indication to UE AS 210.
Step 8: UE AS 210 determines whether it is possible to send upper layer indication(s) and/or associated information and/or QoE report(s) to at least one of the RAN nodes comprised in the current radio configuration. At this stage, the sending is allowed towards RAN node B 220.
Step 9: UE AS 210 is reconfigured to a second radio configuration, comprising RAN node C 225 and RAN node D 230. As an example, a multi-connectivity radio procedure involved in this case can be a “Inter-Master Node handover with Secondary Node change.”
Step 10: As part of the reconfiguration procedure, or associated to it, a signaling connection can be established (e.g. SRB4) between UE AS 210 and RAN node C 225 and/or between UE AS 210 and RAN node D 230.
Step 11: This step is similar to Step 8, and it is executed because the radio configuration for UE AS 210 has changed since then. This time, UE AS 210 determines that upper layer indication(s) and QoE report(s) can be sent to both RAN node C 225 and RAN node D 230.
Step 12: Session S1 is stopped/end in UE App 205.
Step 13: UE App 205 sends to UE AS 210 a Session End/Stop indication for session S1.
Step 14a: UE AS 210 sends Session End/Stop indication to RAN node C 225.
Step 14b: UE AS 210 sends Session End/Stop indication to RAN node D 230.
Step 15: UE App 205 sends to UE AS 210 a QoE report for session S1.
Step 16a: UE AS 210 sends the QoE report to RAN node C 225.
Step 16b: UE AS 210 sends the QoE report to RAN node D 230.

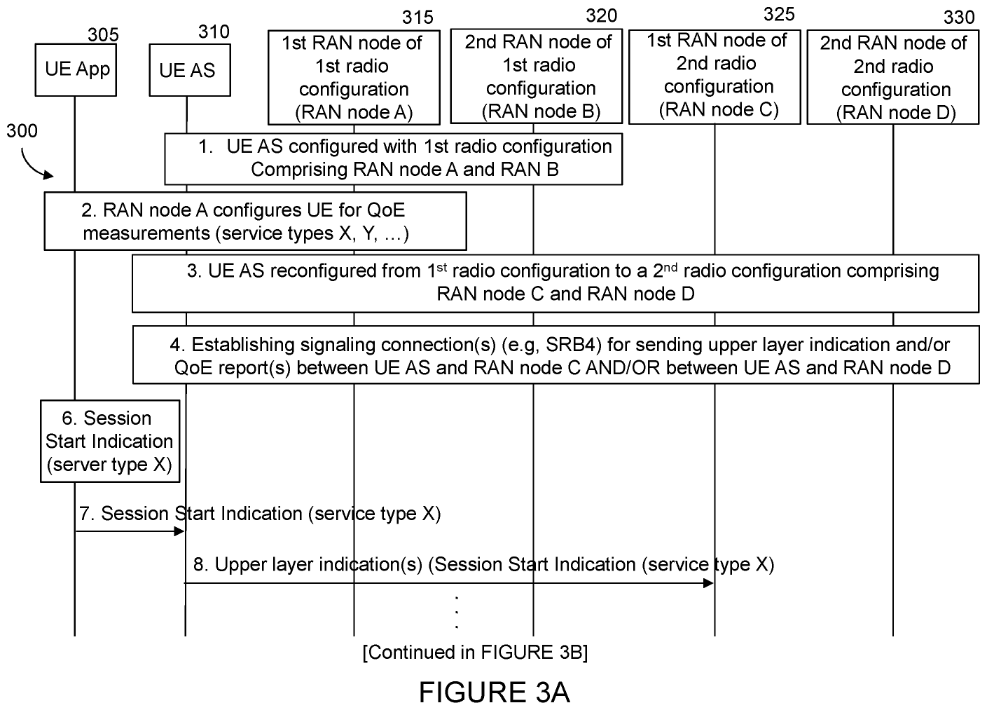

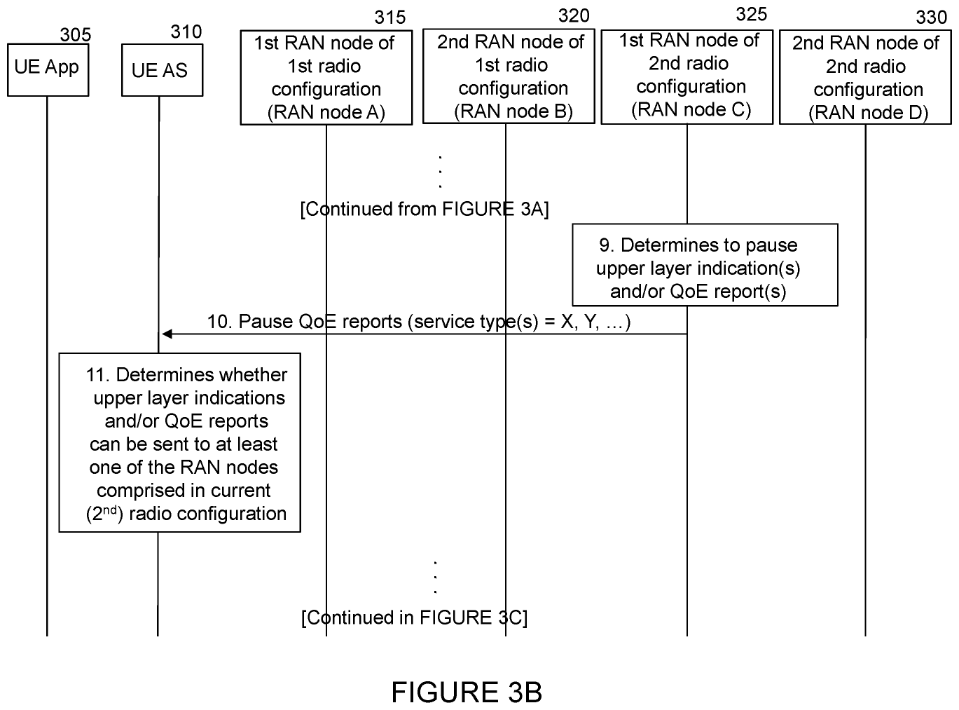

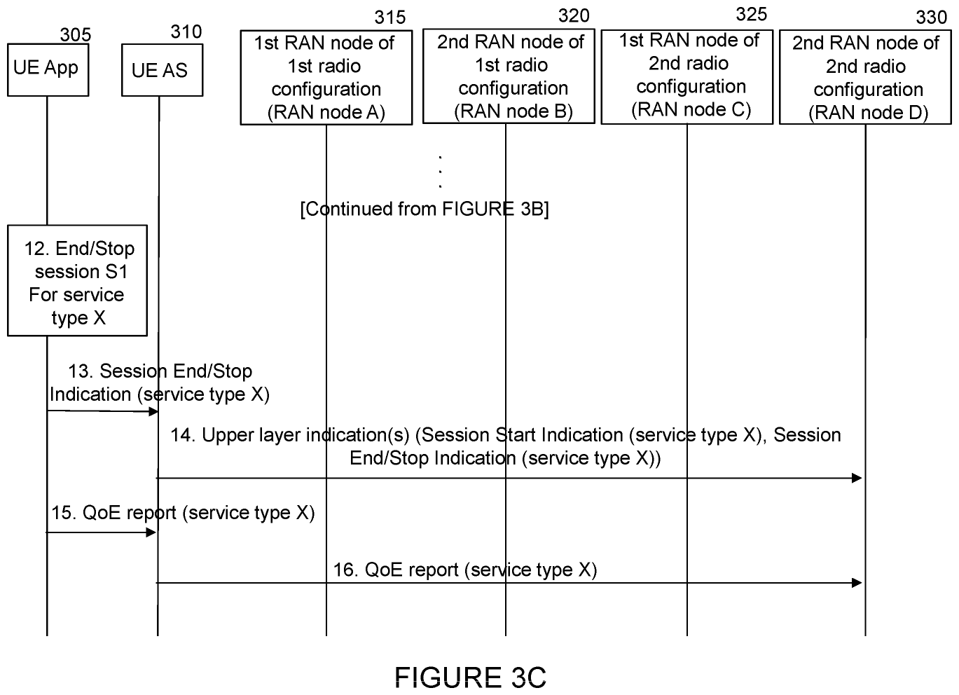

FIGS. 3A, 3B, and 3C illustrate a third high-level example flowchart of an example method 300 where the UE AS is initially configured according to a first radio configuration in multi connectivity and later reconfigured to a second radio configuration, also in multi-connectivity, according to certain embodiments. Specifically, FIGS. 3A, 3B, and 3C illustrate example signalling between a UE App 305, UE AS 310, first RAN node of first radio configuration 315, second RAN node of first radio configuration 320, first RAN node of second radio configuration 325, and second RAN node of second radio configuration 330. A pause indication is sent from the first RAN node of the second radio configuration to UE AS 310. In the flowchart:
The “first RAN node of the first radio configuration” 315 is RAN node A.
The “second RAN node of the first radio configuration” 320 is RAN node B.
The “first RAN node of the second radio configuration” 325 is RAN node C.
The “second RAN node of the second radio configuration” 330 is RAN node D.

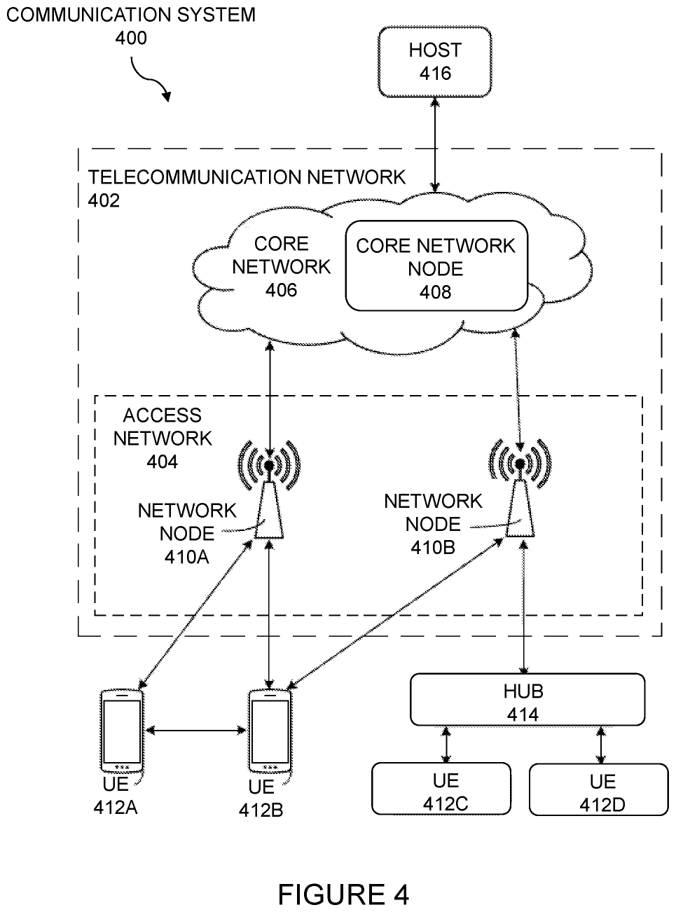

As illustrated in FIG. 4, the method may include one or more or a combination of any of the following steps:
Step 1: UE AS 310 is configured according to a first radio configuration, comprising RAN node A 315 and RAN node B 320.
Step 2: One of the RAN nodes in the first radio configuration (in the example the first RAN node of the first radio configuration, i.e. RAN node A 315) configures UE for QoE measurements. Note that Step 2 may be performed before Step 1, in a particular embodiment.
Step 3: UE AS 310 is reconfigured to a second radio configuration, comprising RAN node C 325 and RAN node D 330. As an example, a multi-connectivity radio procedure involved in this case can be a “Inter-Master Node handover with Secondary Node change”.
Step 4: As part of the reconfiguration procedure, or associated to it, a signaling connection can be established (e.g. SRB4) between UE AS 310 and RAN node C 325 and/or between UE AS 310 and RAN node D 330.
Step 5: UE AS 310 determines whether it is possible to send upper layer indication(s) and/or associated information and/or QoE report(s) to at least one of the RAN nodes comprised in the current radio configuration. At this stage, sending is permitted towards RAN node C 325 and RAN node D 330.
Step 6: A Session S1 starts in UE App 305.
Step 7: UE App 305 sends to UE AS 310 a Session Start indication for session S1.
Step 8: UE AS 310 sends a Session Start indication for session S1 to the first RAN node of the first radio configuration (RAN node A) 315.
Step 9: The first RAN node of the second radio configuration 325 determines to pause the sending of upper layer indication(s) and/or associated information and/or QoE report(s) from UE AS 310.
Step 10: The first RAN node of the second radio configuration 325 sends a pause indication to UE AS 310.
Step 11: This step is similar to Step 5 and it is executed because an indication to pause has been received by UE AS 310. This time UE AS 310 determines that upper layer indication(s) and QoE report(s) can be sent only to RAN node D 330.
Step 12: Session S1 is stopped/end in UE App 305.
Step 13: UE App 305 sends to UE AS 310 a Session End/Stop indication for session S1.
Step 14: UE AS 310 sends Session End/Stop indication to RAN node D 330).
Step 15: UE App 305 sends to UE AS 310 a QoE report for session S1.
Step 16: UE AS 310 sends the QoE report to RAN node D 330.

FIG. 4 shows an example of a communication system 400 in accordance with some embodiments. In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3^{rd} Generation Partnership Project (3GPP) access node or non-3GPP access point. The network nodes 410) facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC). Mobility Management Entity (MME), Home Subscriber Server (HSS). Access and Mobility Management Function (AMF). Session Management Function (SMF). Authentication Server Function (AUSF). Subscription Identifier De-concealing function (SIDF). Unified Data Management (UDM). Security Edge Protection Proxy (SEPP). Network Exposure Function (NEF), and/or a User Plane Function (UPF).

The host 416 may be under the ownership or control of a service provider other than an operator or provider of the access network 404 and/or the telecommunication network 402 and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave. Near Field Communication (NFC) ZigBee. LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi. NR (New Radio) and LTE. i.e. being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios. UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

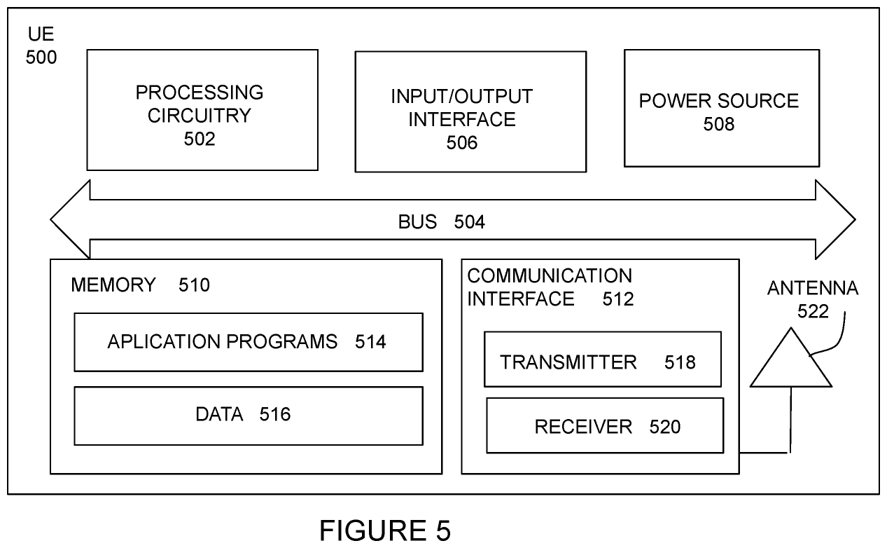

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc, Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication. Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

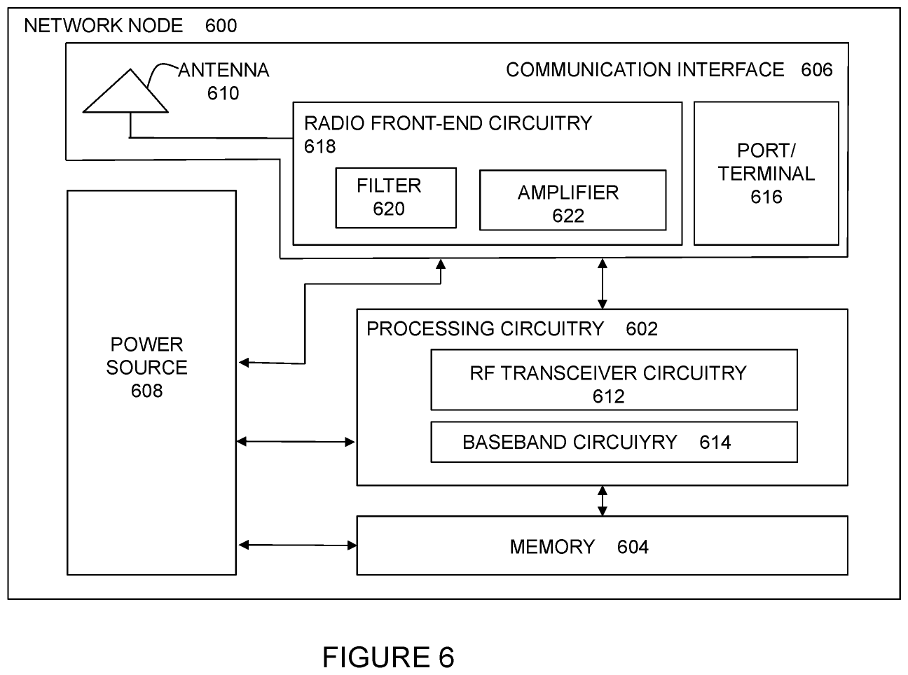

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware: one or more stored computer programs, general-purpose processors, such as a microprocessor or digital signal processor (DSP), together with appropriate software: or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as SIM card.” The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software, or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET). Asynchronous Transfer Mode (ATM), QUIC. Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations. Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs). Operation and Maintenance (O&M) nodes. Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610) may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

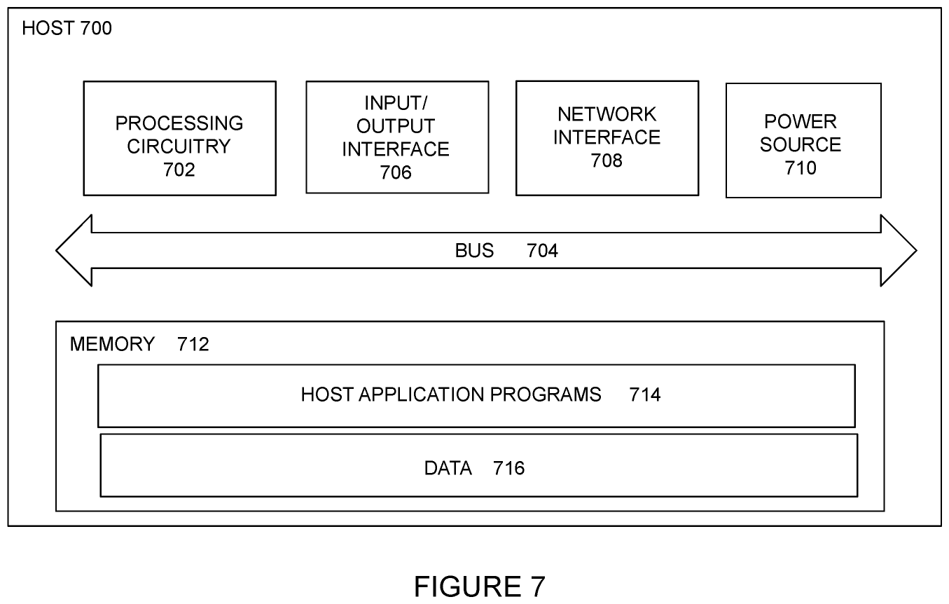

FIG. 7 is a block diagram of a host 700, which may be an embodiment of the host 416 of FIG. 4, in accordance with various aspects described herein.

As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

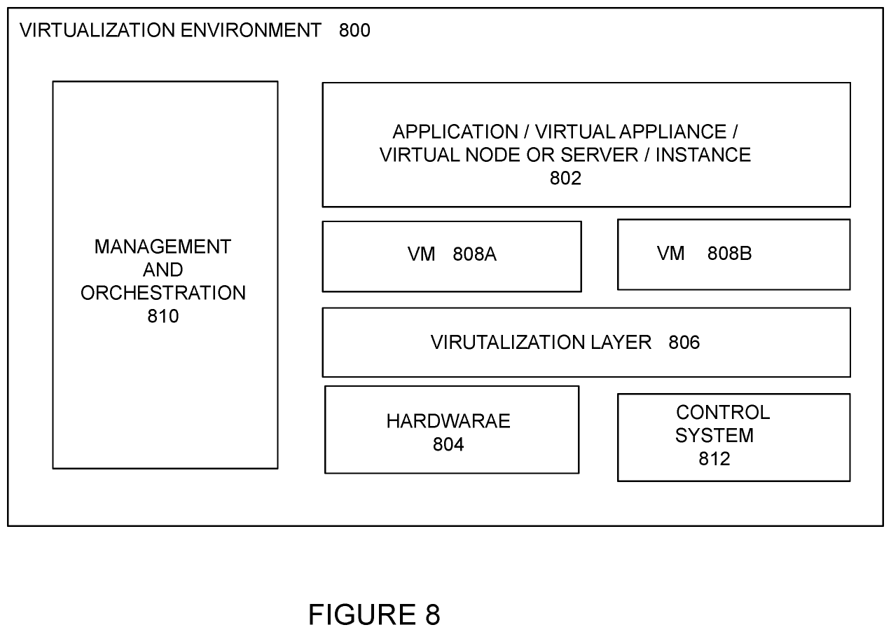

FIG. 8 is a block diagram illustrating a virtualization environment 800 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

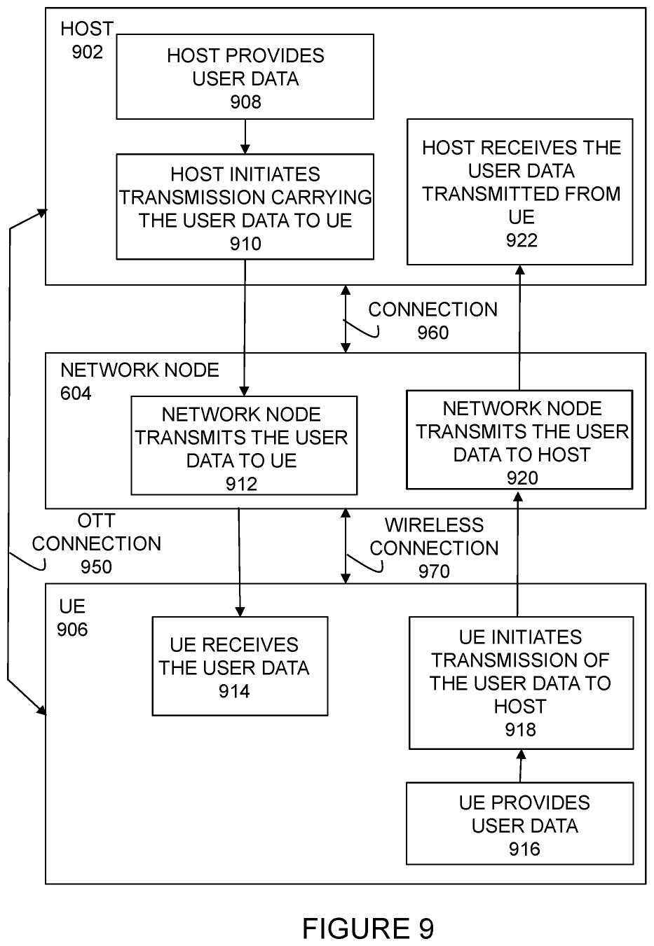

FIG. 9 shows a communication diagram of a host 902 communicating via a network node 904 with a UE 906 over a partially wireless connection in accordance with some embodiments.

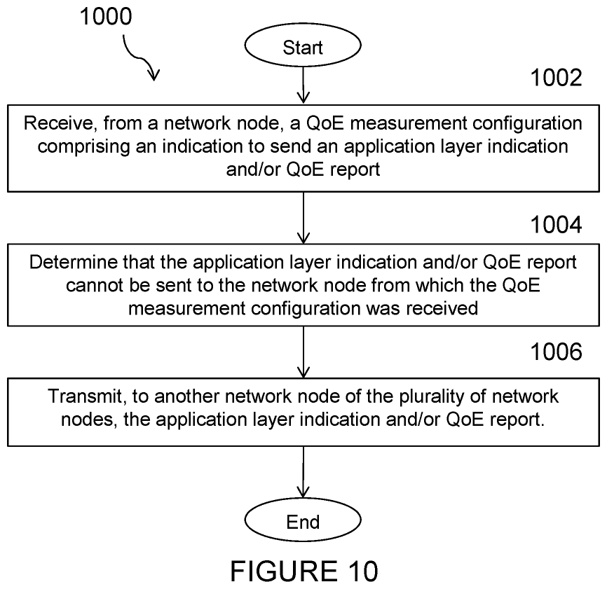

Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 10.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio. VR or AR which it can broadcast, multicast or unicast to UEs. As other examples, the host 902 may be used for energy pricing, remote control of non-time critical electrical load to balance power generation needs, location services, presentation services (such as compiling diagrams etc, from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes: the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

FIG. 10 illustrates a method 1000 by a UE 412 having multi-connectivity to a plurality of network nodes 410, according to certain embodiments. The method begins at step 1002 when the UE 412 receives, from a network node 410A of the plurality of network nodes, a QoE measurement configuration comprising an indication to send an application layer indication and/or QoE report. At step 1004, the UE 412 determines that the application layer indication and/or QoE report cannot be sent to the network node from which the QoE measurement configuration was received. At step 1006, the UE 412 transmits, to another network node 410B of the plurality of network nodes, the application layer indication and/or QoE report.

In a particular embodiment, when determining that the application layer indication and/or QoE report cannot be sent to the network node, the UE receives an indication to pause sending the application layer indication and/or QoE report to the network node.

In a particular embodiment, the UE transmits the application layer indication and/or QoE report to at least the other network node when, after receiving the indication to pause sending the application layer indication and/or QoE report, the UE does not receive a further indication to resume sending the application layer indication and/or QoE report to the network node.

In a particular embodiment, the indication to pause sending the application layer indication and/or QoE report applies to one application layer indication and/or one QoE report associated with one QoE measurement configuration of the UE.

In a particular embodiment, the indication to pause sending the application layer indication and/or QoE report applies to: all application layer indications and/or QoE reports associated with one QoE measurement configuration, or all application layer indications and/or QoE reports associated with all QoE measurement configurations.

In a particular embodiment, the UE is reconfigured from a first radio configuration to a second radio configuration, and the network node and the other network node are associated with the first radio configuration.

In a particular embodiment, the UE is reconfigured from a first radio configuration to a second radio configuration, and the network node and the other network node are associated with the second radio configuration.

In a particular embodiment, the second radio configuration removes at least one of the network node and the other network node as serving nodes with respect to the UE.

In a particular embodiment, the second radio configuration replaces at least one of the network node and the other network node as serving nodes with respect to the UE.

In a particular embodiment, the second radio configuration adds at least one of the network node and the other network node as serving nodes with respect to the UE.

In a particular embodiment, the second radio configuration retains the network node as a serving node with respect to the UE and adds the other network node as a serving node with respect to the UE.

In a particular embodiment, the second radio configuration removes the network node as a serving node with respect to the UE and adds the other network node as a serving node with respect to the UE.

In a particular embodiment, the UE 412 receives an indication that the other network node can receive the application layer indication and/or QoE report.

In a particular embodiment, in response to receiving the indication to pause sending the application layer indication and/or QoE report, the UE sends a stop indication for a session running in a UE application layer.

In a particular embodiment, when determining that the application layer indication and/or QoE report cannot be sent to the network node from which the QoE measurement configuration was received, the UE determines that a SRB is not configured between the UE and the network node.

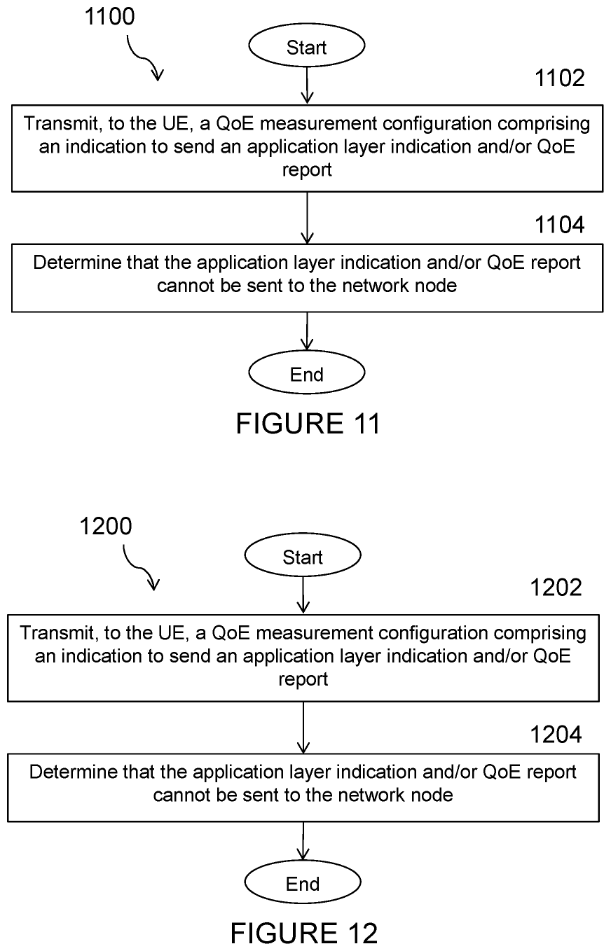

FIG. 11 illustrates a method 1100 by a network node 410A serving a UE 412 that has multi-connectivity to the network node and at least another network node 410B, according to certain embodiments. The method begins at step 1102 when the network node 410A transmits, to the UE, a QoE measurement configuration comprising an indication to send an application layer indication and/or QoE report. At step 1104, the network node 410A determines that the application layer indication and/or QoE report cannot be sent to the network node.

In a particular embodiment, based on determining that the application layer indication and/or QoE report cannot be sent to the UE, the network node 410A transmits, to the UE 412, an indication to pause sending the application layer indication and/or QoE report to the network node.

In a particular embodiment, the UE is configured to transmit the application layer indication and/or QoE report to the other network node when, after receiving the indication to pause sending the application layer indication and/or QoE report, the UE does not receive a further indication to resume sending the application layer indication and/or QoE report to the network node.

In a particular embodiment, the indication to pause sending the application layer indication and/or QoE report applies to one application layer indication and QoE report associated with one QoE measurement configuration of the UE.

In a particular embodiment, the indication to pause sending the application layer indication and/or QoE report applies to: all application layer indications and/or QoE reports associated with one QoE measurement configuration, or all application layer indications and/or QoE reports associated with all QoE measurement configurations.

In a particular embodiment, the UE is reconfigured from a first radio configuration to a second radio configuration, and the network node and the other network node are associated with the first radio configuration.

In a particular embodiment, the UE is reconfigured from a first radio configuration to a second radio configuration, and the network node and the other network node are associated with the second radio configuration.

In a particular embodiment, the second radio configuration removes at least one of the network node and the other network node as serving nodes with respect to the UE.

In a particular embodiment, the second radio configuration replaces at least one of the network node and the other network node as serving nodes with respect to the UE.

In a particular embodiment, the second radio configuration adds at least one of the network node and the other network node as serving nodes with respect to the UE.

In a particular embodiment, the second radio configuration retains the network node as a serving node with respect to the UE and adds the other network node as a serving node with respect to the UE.

In a particular embodiment, the second radio configuration removes the network node as a serving node with respect to the UE and adds the other network node as a serving node with respect to the UE.

In a particular embodiment, the network node transmits, to the UE, an indication that the other network node can receive the application layer indication and/or QoE report.

In a particular embodiment, when determining that the application layer indication and/or QoE report cannot be sent to the network node from which the QoE measurement configuration was received, the network node determines that a SRB is not configured between the UE and the network node.

FIG. 12 illustrates another method 1200 by a network node 410A serving a UE 412 that has multi-connectivity to the network node 410A and at least another network node 410B, according to certain embodiments. The method begins at step 1202 when the network node 410A transmits, to the other network node 410B, a request to receive an application layer indication and/or QoE report of the UE. At step 1204, the network node 410A receives the application layer indication and/or QoE report of the UE 412.

In a particular embodiment, the application layer indication and/or QoE report is received from the UE.

In a particular embodiment, the application layer indication and/or QoE report is received from another network node.

In a particular embodiment, the network node receives the application layer indication and/or QoE report when at least one of: the UE receives an indication to pause sending the application layer indication and/or QoE report from the other network node, and after the UE receives the indication to pause sending the application layer indication and/or QoE report to the other network node, the UE does not receive a further indication to resume sending the application layer indication and/or QoE report to the other network node.

In a particular embodiment, the indication to pause sending the application layer indication and/or QoE report applies to one application layer indication and/or QoE report associated with one application layer configuration of the UE.

In a particular embodiment, the indication to pause sending the application layer indication and/or QoE report applies to: all application layer indications and/or QoE reports associated with one QoE measurement configuration, or all application layer indications and/or QoE reports associated with all QoE measurement configurations.

In a particular embodiment, the UE is reconfigured from a first radio configuration to a second radio configuration, and the network node and the other network node are associated with the first radio configuration.

In a particular embodiment, the UE is reconfigured from a first radio configuration to a second radio configuration, and the network node and the other network node are associated with the second radio configuration.

In a particular embodiment, the second radio configuration removes at least one of the network node and the other network node as serving nodes with respect to the UE.

In a particular embodiment, the second radio configuration replaces at least one of the network node and the other network node as serving nodes with respect to the UE.

In a particular embodiment, the second radio configuration adds at least one of the network node and the other network node as serving nodes with respect to the UE.

In a particular embodiment, the second radio configuration retains the other network node as a serving node with respect to the UE and adds the network node as a serving node with respect to the UE.

In a particular embodiment, the second radio configuration removes the other network node as a serving node with respect to the UE and adds the network node as a serving node with respect to the UE.

In a particular embodiment, the network node transmits, to at least one of the UE and the other network node, an indication that the network node can receive the application layer indication and/or QoE report.

In a particular embodiment, the application layer indication and/or the QoE report of the UE comprises at least one of: all application layer indications and/or QoE reports: all application layer indications and/or QoE reports associated with a service type, service sub-type, or application: at least one application layer indication and/or QoE report concerning a service type; and at least one timestamp of at least one application layer indication and/or QoE report.

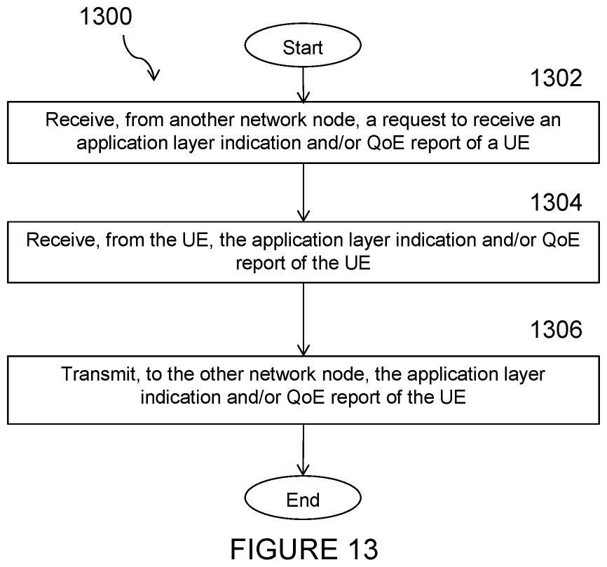

FIG. 13 illustrates another method 1300 by a network node 410A serving a UE 412 that has multi-connectivity to the network node 410A and at least another network node 410B, according to certain embodiments. The method begins at step 1302 when the network node 410A receives, from the other network node 410B, a request to receive an application layer indication and/or QoE report of the UE. At step 1304, the network node 410A receives, from the UE 412, the application layer indication and/or QoE report of the UE. At step 1306, the network node 410A transmits, to the other network node 410B, the application layer indication and/or QoE report of the UE.

In a particular embodiment, the application layer indication and/or QoE report comprises at least one of: all application layer indications and/or QoE reports: all application layer indications and/or QoE reports associated with a service type, service sub-type, or application: at least one application layer indication and/or QoE report concerning a service type; and at least one timestamp of at least one application layer indication and/or QoE report.

In a particular embodiment, the application layer indication and/or QoE report is received from the UE.

In a particular embodiment, the application layer indication and/or QoE report is received from another network node.

In a particular embodiment, the other network node receives the application layer indication and/or QoE report when at least one of: the UE receives an indication to pause sending the application layer indication and/or QoE report from the network node, and after the UE receives the indication to pause sending the application layer indication and/or QoE report to the network node, the UE does not receive a further indication to resume sending the application layer indication and/or QoE report to the network node after the UE receives the indication to pause sending the application layer indication and/or QoE report to the network node.

In a particular embodiment, the indication to pause sending the application layer indication and/or QoE report applies to one application layer indication and/or QoE report associated with one application layer configuration of the UE.

In a particular embodiment, the indication to pause sending the application layer indication and/or QoE report applies to: all application layer indications and/or QoE reports associated with one QoE measurement configuration, or all application layer indications and/or QoE reports associated with all QoE measurement configurations.

In a particular embodiment, the UE is reconfigured from a first radio configuration to a second radio configuration, and the network node and the other network node are associated with the first radio configuration.

In a particular embodiment, the UE is reconfigured from a first radio configuration to a second radio configuration, and the network node and the other network node are associated with a second radio configuration.

In a particular embodiment, the second radio configuration removes at least one of the network node and the other network node as serving nodes with respect to the UE.

In a particular embodiment, the second radio configuration replaces at least one of the network node and the other network node as serving nodes with respect to the UE.

In a particular embodiment, the second radio configuration adds at least one of the network node and the other network node as serving nodes with respect to the UE.

In a particular embodiment, the second radio configuration retains the network node as a serving node with respect to the UE and adds the other network node as a serving node with respect to the UE.

In a particular embodiment, the second radio configuration removes the network node as a serving node with respect to the UE and adds the other network node as a serving node with respect to the UE.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

### Example Embodiments

### Group A Example Embodiments

Example Embodiment A1. A method by a user equipment for Quality of Experience (QUE) reporting, the UE having multi-connectivity to a plurality of network nodes, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for receiving Quality of Experience (QUE) reporting from a wireless device having multi-connectivity to a plurality of network nodes, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for Quality of Experience (QUE) reporting, the UE having multi-connectivity to a plurality of network nodes, the method comprising: receiving, from at least a first network node of the plurality of network nodes, an indication to pause sending QoE reporting; and transmitting, to at least a second network node of the plurality of network nodes, information associated with a QoE report.

Example Embodiment C2. The method of Example Embodiment C1, wherein the information associated with the QoE report comprises at least one of: an upper level indication, and the QoE report.

Example Embodiment C3. The method of any one of Example Embodiments C1 to C2, further comprising determining that it is possible to send the information associated with the QoE report to at least the second network node.

Example embodiment C4. The method of Example Embodiment C3, wherein the determining is performed after receiving the indication to pause sending the QoE reporting from the first network node.

Example Embodiment C5. The method of any one of Example Embodiments C1 to C4, wherein the UE is configured, according to a first configuration associated with the first network node.

Example Embodiment C6. The method of Example Embodiment C5, further comprising receiving configuration information associated with a second configuration, wherein the second configuration removes the first network node as a serving node with respect to the UE and adds the second network node as a serving node with respect to the UE.

Example Embodiment C7. The method of any one of Example Embodiments C1 to C4, wherein the UE is configured according to a first configuration associated with the first network node and the second network node.

Example Embodiment C8. The method of Example Embodiment C7, further comprising receiving configuration information associated with a second configuration, wherein the second configuration removes at least one of the first network node and the second network node as serving nodes with respect to the UE.

Example Embodiment C9. The method of Example Embodiment C8, wherein the second configuration adds at least one of a third network node and a fourth network node as serving nodes with respect to the UE.

Example Embodiment C10. The method of any one of Example Embodiments C1 to C4, wherein, the UE is configured to: based on a first configuration, send a first QoE report to the first network node, and based on the first configuration, send a second QoE report to the second network node.

Example Embodiment C11. The method of any one of Example Embodiments C1 to C4, wherein the UE is configured to: based on a first configuration, send a first QoE report to the first network node, and based on a second configuration, send a second QoE report to the second network node.

Example Embodiment C12. The method of any one of Example Embodiments C10 to C11, wherein the first QoE report is same as the second QoE report.

Example Embodiment C13. The method of any one of Example Embodiments C10 to C11, wherein the first QoE report is different from the second QoE report.

Example Embodiment C14. The method of any one of Example Embodiments C10 to C13, further comprising receiving first configuration information associated with at least one of the first configuration and the second configuration.

Example Embodiment C15. The method of Example Embodiment 14 further comprising receiving additional configuration information associated with a third configuration, wherein the third configuration configures the UE to send a third QoE report to a third network node.

Example Embodiment C16. The method of Example Embodiment C15, wherein the third configuration configures the UE to send the fourth QoE report to a fourth network node.

Example Embodiment C17. The method of Example Embodiment C16, wherein the fourth QoE report is same as the third QoE report.

Example Embodiment C18. The method of Example Embodiment C16, wherein the fourth QoE report is different from the third QoE report.

Example Embodiment C19. The method of any one of Example Embodiments C1 to C18, further comprising: starting a session in an UE application layer; and transmitting a session start indication for the session.

Example Embodiment C20. The method of any one of Example Embodiment C19, further comprising: in response to receiving the indication to pause sending QoE reporting, sending a stop indication for the session.

Example Embodiment C21. The method of any one of Example Embodiments C19 to C20, wherein the information associated with the QoE report is associated with the session with the first network node.

Example Embodiment C22. The method of any one of Example Embodiments C1 to C21, further comprising: after receiving the indication to pause sending QoE reporting, receiving information configuring the UE to send the information associated with the QoE report to at least a third network node of the plurality of network nodes; and based on the information, sending the information associated with the QoE report to at least the third network node.

Example Embodiment C23. The method of Example Embodiments C1 to C22, further comprising: providing user data; and forwarding the user data to a host via the transmission to the network node.

Example Embodiment C24. A user equipment comprising processing circuitry configured to perform any of the methods of Example Embodiments C1 to C23.

Example Embodiment C25. A wireless device comprising processing circuitry configured to perform any of the methods of Example Embodiments C1 to C23.

Example Embodiment C26. A computer program comprising instructions which when executed on a computer perform any of the methods of Example Embodiments C1 to C23.

Example Embodiment C27. A computer program product comprising computer program, the computer program comprising instructions which when executed on a computer perform any of the methods of Example Embodiments C to C23.

Example Embodiment C28. A non-transitory computer readable medium storing instructions which when executed by a computer perform any of the methods of Example Embodiments C1 to C23.

### Group E Example Embodiments

Example Embodiment E1. A user equipment for Quality of Experience (QUE) reporting in multi-connectivity, comprising: processing circuitry configured to perform any of the steps of any of the Group A and C Example Embodiments; and power supply circuitry configured to supply power to the processing circuitry.

Example Embodiment E2. A network node for Quality of Experience (QUE) reporting in multi-connectivity, the network node comprising: processing circuitry configured to perform any of the steps of any of the Group B and D Example Embodiments: power supply circuitry configured to supply power to the processing circuitry.

Example Embodiment E3. A user equipment (UE) for Quality of Experience (QUE) reporting in multi-connectivity, the UE comprising: an antenna configured to send and receive wireless signals: radio front-end circuitry connected to the antenna and to processing circuitry, and configured to condition signals communicated between the antenna and the processing circuitry; the processing circuitry being configured to perform any of the steps of any of the Group A and C Example Embodiments: an input interface connected to the processing circuitry and configured to allow input of information into the UE to be processed by the processing circuitry: an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Emboidment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment, UE, having multi-connectivity to a plurality of network nodes, the method comprising:
receiving, from a network node of the plurality of network nodes, a Quality of Experience, QoE, measurement configuration comprising an indication to send an application layer indication and/or QoE report;
determining that the application layer indication and/or QoE report cannot be sent to the network node from which the QoE measurement configuration was received; and
transmitting, to another network node of the plurality of network nodes, the application layer indication and/or QoE report.

2. The method of claim 1, wherein determining that the application layer indication and/or QoE report cannot be sent to the network node comprises receiving an indication to pause sending the application layer indication and/or QoE report to the network node.

3. The method of claim 2, wherein the UE transmits the application layer indication and/or QoE report to at least the other network node when, after receiving the indication to pause sending the application layer indication and/or QoE report, the UE does not receive a further indication to resume sending the application layer indication and/or QoE report to the network node.

4. The method of claim 2, wherein the indication to pause sending the application layer indication and/or QoE report applies to one application layer indication and/or one QoE report associated with one QoE measurement configuration of the UE.

5. The method of claim 2, wherein the indication to pause sending the application layer indication and/or QoE report applies to:
all application layer indications and/or QoE reports associated with one QoE measurement configuration, or
all application layer indications and/or QoE reports associated with all QoE measurement configurations.

6. The method of claim 1, wherein:
the UE is reconfigured from a first radio configuration to a second radio configuration, and
the network node and the other network node are associated with the first radio configuration.

7. The method of claim 1, wherein:
the UE is reconfigured from a first radio configuration to a second radio configuration, and
the network node and the other network node are associated with the second radio configuration.

8. The method of claim 6, wherein the second radio configuration removes at least one of the network node and the other network node as serving nodes with respect to the UE.

9. The method of claim 6, wherein the second radio configuration replaces at least one of the network node and the other network node as serving nodes with respect to the UE.

10. The method of claim 6, wherein the second radio configuration adds at least one of the network node and the other network node as serving nodes with respect to the UE.

11. The method of claim 6, wherein the second radio configuration retains the network node as a serving node with respect to the UE and adds the other network node as a serving node with respect to the UE.

12. The method of claim 6, wherein the second radio configuration removes the network node as a serving node with respect to the UE and adds the other network node as a serving node with respect to the UE.

13. The method of claim 1, comprises receiving an indication that the other network node can receive the application layer indication and/or QoE report.

14. The method of claim 1, comprising:
in response to receiving the indication to pause sending the application layer indication and/or QoE report, sending a stop indication for a session running in a UE application layer.

15. The method of claim 1, wherein determining that the application layer indication and/or QoE report cannot be sent to the network node from which the QoE measurement configuration was received comprises determining that a signaling radio bearer, SRB, is not configured between the UE and the network node.

16. A method by a network node serving a User Equipment, UE, that has multi-connectivity to the network node and at least another network node, the method comprising:
transmitting, to the UE, a Quality of Experience, QoE, measurement configuration comprising an indication to send an application layer indication and/or QoE report; and
determining that the application layer indication and/or QoE report cannot be sent to the network node.

17. The method of claim 16, comprising:
based on determining that the application layer indication and/or QoE report cannot be sent to the UE, transmitting, to the UE, an indication to pause sending the application layer indication and/or QoE report to the network node.

18. The method of claim 17, wherein the UE is configured to transmit the application layer indication and/or QoE report to the other network node when, after receiving the indication to pause sending the application layer indication and/or QoE report, the UE does not receive a further indication to resume sending the application layer indication and/or QoE report to the network node.

19. The method of claim 17, wherein the indication to pause sending the application layer indication and/or QoE report applies to one application layer indication and QoE report associated with one QoE measurement configuration of the UE.

20. The method of claim 17, wherein the indication to pause sending the application layer indication and/or QoE report applies to:
all application layer indications and/or QoE reports associated with one QoE measurement configuration, or
all application layer indications and/or QoE reports associated with all QoE measurement configurations.

21.-58. (canceled)

59. A user equipment, UE, having multi-connectivity to a plurality of network nodes, the UE being configured to:
receive, from a network node of the plurality of network nodes, a Quality of Experience, QoE, measurement configuration comprising an indication to send an application layer indication and/or QoE report;
determine that the application layer indication and/or QoE report cannot be sent to the network node from which the QoE measurement configuration was received; and
transmit, to another network node of the plurality of network nodes, the application layer indication and/or QoE report.

60. (canceled)

61. A network node serving a User Equipment, UE, that has multi-connectivity to the network node and at least another network node, the network node being configured to:
transmit, to the UE, a Quality of Experience, QoE, measurement configuration comprising an indication to send an application layer indication and/or QoE report; and
determine that the application layer indication and/or QoE report cannot be sent to the network node.

62.-66. (canceled)
